(19) United States
(12) Patent Application Publication
(10) Pub. No.: US 2026/0177735 A1
(43) Pub. Date: Jun. 25, 2026

(54) DISPLAY

(71) Applicant: Neil NEWELL, Shermanbury, Sussex (GB)

(72) Inventor: Neil NEWELL, Shermanbury, Sussex (GB)

(21) Appl. No.: 19/123,808

(22) PCT Filed: Oct. 13, 2023
(86) PCT No.: PCT/GB2023/052665

§ 371 Date: Apr. 24, 2025

(30) Foreign Application Priority Data
Oct. 24, 2022 (GB) 2215743.2

(51) Int. Cl. F21V 8/00

(52) U.S. Cl. CPC G02B 6/0068; G02B 6/0055; G02B 6/0073

(57) ABSTRACT

There is described a display comprising: a mirror arranged to rotate about an axis of rotation; and a plurality of light emitting elements arranged to project light onto the mirror; wherein: a first light emitting element of the plurality of light emitting elements is offset from a second light emitting element of the plurality of light emitting elements in a direction aligned with the axis of rotation; and the first light emitting element is offset from the second light emitting element of the plurality of light emitting elements in a direction perpendicular to the axis of rotation.

### FIELD OF INVENTION

The present invention relates to a display and to a headset and/or projector comprising the display. In particular, the display may be used in a virtual reality headset, an augmented reality headset, and/or a mixed reality headset. The present disclosure also relates to methods of operating and manufacturing the display as well as a kit of parts for the display and a system comprising the display.

### BACKGROUND

One of the problems with existing virtual reality or augmented reality headsets, e.g. those that use liquid crystal displays (LCDs), is the so-called ‘screen door’ effect. The screen door effect occurs when, due to the proximity of a display to the eye, a wearer is able to see the gaps between pixels on a screen. This issue arises because each pixel requires control and power connections that require an amount of space around the pixel. These areas show up as dark areas between pixels that are visible from close range. The ratio of the light-emitting areas of the pixels to the dark areas of the pixels is known as the ‘fill factor’, and for most displays—in particular those that will be viewed from close range—it is desirable to have a high fill factor.

A display that achieves an increased fill factor (as compared to, say, an LCD display) is the ‘Private Eye’ scanning headset display. This display is described in U.S. Pat. Nos. 4,934,773 and 5,003,300 and is shown in FIG. 1, which is taken from U.S. Pat. No. 4,934,773.

With the ‘Private Eye’ display, a linear array of light emitting elements 18 (e.g. light emitting diodes (LEDs)) is located in the vicinity of an oscillating (or vibrating) mirror 22. The light emitting elements are arranged adjacent a lens 20 so that light from the light emitting elements passes through the lens before reaching the mirror. The lens collimates the light from the light emitting elements so that collimated light impacts the oscillating mirror and thereafter passes towards a user (e.g. into the eye of a user).

As the mirror oscillates, the point on the mirror onto which the light from the light emitting elements is projected varies so that by selectively illuminating the light emitting elements it is possible to display various images on the mirror, which images are then visible to the user. Due to the persistence of vision, when the mirror is oscillated at sufficient frequencies (e.g. 100 Hz) the vibration of the mirror causes each light emitting element to appear to the user as a line so that an image may be composed by selectively operating the light emitting elements.

By turning a light emitting element on and off at a high frequency in synchronism with the mirror, the line associated with that element can be broken into individual pixels (e.g. a light emitting element can be turned on and off 1024 times during a single mirror scan to give a horizontal resolution of 1024 pixels).

In this way, an image can be formed by combining a single line of light emitting elements with an oscillating mirror. Advantageously, with appropriate timing of the mirror oscillation and light emitting element operation, the line associated with each light emitting element appears to the user as an unbroken line.

### SUMMARY OF THE DISCLOSURE

Aspects and embodiments of the present invention are set out in the appended claims. These and other aspects and embodiments of the invention are also described herein.

According to an aspect of the present disclosure, there is described a display comprising: a mirror arranged to rotate about an axis of rotation; and a plurality of light emitting elements arranged to project light onto the mirror.

According to an aspect of the present disclosure, there is described a display comprising: a mirror arranged to rotate about an axis of rotation; and a plurality of light emitting elements arranged to project light onto the mirror; wherein: a first light emitting element of the plurality of light emitting elements is offset from a second light emitting element of the plurality of light emitting elements in a direction aligned with (and/or parallel to) the axis of rotation; and the first light emitting element is offset from the second light emitting element of the plurality of light emitting elements in a direction perpendicular to the axis of rotation.

Preferably, the offset in the direction aligned with the axis of rotation is less than a side length and/or diameter of the light emitting elements. Preferably, the offset in the direction perpendicular to the axis of rotation is less than a side length and/or diameter of the light emitting elements.

Preferably, the display comprises a plurality of lines of light emitting elements, wherein each of the lines of light emitting elements comprises one or more light emitting elements, and wherein: the light emitting elements of a first line of light emitting elements are offset from the light emitting elements of a second line of light emitting elements in a direction aligned with the axis of rotation of the mirror; and the light emitting elements of the first line are offset from the light emitting elements of the second line in a direction perpendicular to the axis of rotation.

Preferably, each of the lines comprises a plurality of light emitting elements.

Preferably, the light emitting elements are offset in the direction aligned with the axis of rotation by a distance that is less than one or more of: the diameter of the light emitting elements; and a side length of the light emitting elements.

Preferably, each of a/the lines of light emitting elements is arranged to have a fill factor along the axis of rotation that is less than or equal to 66%, less than or equal to 50%, and/or less than or equal to 33%.

Preferably, each of a/the lines of light emitting elements is arranged to have a percentage fill factor along the axis of rotation that is approximately equal to 100 divided by the number of lines of light emitting elements, and/or 100 divided by the number of lines of a specific type of light emitting elements.

Preferably, the combination of lines of light emitting elements is arranged to have a fill factor along the axis of rotation that is one or more of: greater than or equal to 90%, greater than or equal to 95%, greater than or equal to 100%, and/or substantially equal to 100%.

Preferably, the combination of lines of light emitting elements is arranged to have a fill factor along the axis of rotation that is one or more of: less than or equal to 120%, less than or equal to 110%, less than or equal to 100%, and/or substantially equal to 100%.

Preferably, the light emitting elements are arranged to output a rectangular pattern of light (e.g. by comprising masks that are a part of the light emitting elements).

Preferably, the light emitting elements are rectangular and/or square.

According to an aspect of the present disclosure, there is described a display comprising: a mirror arranged to rotate about an axis of rotation; and a plurality of light emitting elements arranged to project light onto the mirror; wherein the light emitting elements are rectangular light emitting elements.

Preferably, each of the light emitting elements is the same shape.

Preferably, each of the light emitting elements comprises a plurality of constituent light emitting elements (or light emitting components). Preferably, each of the light emitting elements comprises a plurality of constituent light emitting elements of different types and/or colours. Preferably, each of the light emitting elements comprises a red light emitting element, a green light emitting element, and a blue light emitting element. It will be appreciated that the light emitting elements may (or may not) comprise further constituent light emitting elements.

Preferably, the display comprises a plurality of lines of different types of light emitting elements. Preferably, the display comprises a plurality of lines of different colours of light emitting elements. Preferably, the display comprises a plurality of lines of red light emitting elements, a plurality of lines of green light emitting elements, and a plurality of lines of blue light emitting elements. Preferably, the display comprises at least two lines of each type of light emitting element, wherein, for each type of light emitting elements, the light emitting elements of a first line of said type are offset from the light emitting elements of a second line of said type along the axis of rotation of the mirror.

Preferably, the display comprises a lens located between the light emitting elements and the mirror. Preferably, the lens is arranged to collimate the light emitted by the light emitting elements. Preferably, the lens is arranged to magnify the light emitted by the light emitting elements. Preferably, the lens is arranged to focus the light emitted by the light emitting elements.

Preferably, each of the light emitting elements is operated independently.

Preferably, each of the light emitting elements is arranged to be operated independently so as to project a line of pixels onto the mirror as the mirror rotates.

Preferably, each light emitting element is operated so as to project a line of light onto the mirror. Preferably, the (e.g. horizontal) fill factor of each line of light is greater than or equal to 75%, greater than or equal to 90%, greater than or equal to 95%, greater than or equal to 100%, and/or substantially 100%.

Preferably, the mirror is arranged to rotate (and/or oscillate) at a frequency of at least 30 Hz, at least 36 Hz, at least 50 Hz, at least 100 Hz, and/or at least 200 Hz.

Preferably, the mirror is attached to a vibrating element via a spring flexure. Preferably, the spring flexure is resonant at a desired frequency of rotation of the mirror.

Preferably, the display (and/or the mirror) comprises a mirror galvanometer.

Preferably, the display comprises at least two lines of light emitting elements, at least five lines of light emitting elements, and/or at least ten lines of light emitting elements.

Preferably, the display comprises a plurality of sections of light emitting elements. Preferably, each section is aligned perpendicular to the direction of the axis of rotation of the mirror. Preferably, each section is offset in the direction of the axis of rotation of the mirror.

Preferably, the display comprises a line of light emitting elements that is angled with respect to the axis of rotation.

Preferably, the display comprises at least 20 light emitting elements, at least 50 light emitting elements, at least 100 light emitting elements, at least 500 light emitting elements and/or at least 1000 light emitting elements.

Preferably, a, and/or each, line of light emitting elements comprises at least 10 light emitting elements, at least 20 light emitting elements, at least 50 light emitting elements, at least 250 light emitting elements and/or at least 500 light emitting elements.

Preferably, an input signal provided to the light emitting elements has a frequency of at least 50 kHz, at least 100 kHz, and/or at least 200 kHz.

Preferably, the light emitting elements are arranged to provide a resolution in the direction perpendicular to the axis of rotation that is at least 500 pixels, at least 1000 pixels, and/or at least 2000 pixels.

Preferably, an input signal provided to the light emitting elements can be operated so as to have a duty cycle of less than 50%, less than 40%, and/or less than 30%.

Preferably, an input signal provided to the light emitting elements can be operated so as to have a duty cycle of greater than 50%, greater than 60%, and/or greater than 70%.

Preferably, an input signal provided to the light emitting elements can be operated so as to have a duty cycle of 100%.

Preferably, one or more, or each, of the light emitting elements is associated with a mask that is arranged to block and/or filter a portion of the light emitted by said light emitting elements, preferably a photolithographic mask.

According to another aspect of the present disclosure, there is described a display comprising: a mirror arranged to rotate about an axis of rotation; and a plurality of light emitting elements arranged to project light onto the mirror; wherein one or more, or each, of the light emitting elements is associated with a mask that is arranged to block and/or filter a portion of the light emitted by said light emitting elements, preferably a photolithographic mask.

Preferably, the light emitting elements comprise rectangular light emitting elements. Optionally, the rectangular light emitting elements comprise non-rectangular elements combined with rectangular masks.

Preferably, each mask is arranged to allow the passage of light through an aperture of the mask. Preferably, the aperture is rectangular. Optionally, the aperture is square.

Preferably, each mask is arranged to block the passage of light away from (and/or other than from) the aperture.

Preferably, the masks are sized so as to provide a fill factor in the direction of the axis of rotation that is one or more of: greater than or equal to 90%, greater than or equal to 95%, greater than or equal to 100%, and/or substantially equal to 100%.

Preferably, the masks are sized so as to provide a fill factor in the direction of the axis of rotation that is one or more of: less than or equal to 120%, less than or equal to 110%, less than or equal to 100%, and/or substantially equal to 100%.

Preferably, each mask is arranged to block a specific colour of light and/or each mask is arranged to block only a portion of the light incident on the mask.

Preferably, one or more of the light emitting elements is associated with a light guiding element that is arranged to receive light from the associated light emitting element at a first end and to emit the light from a second end. Preferably, each of the light emitting elements is associated with a light guiding element.

Preferably, one or more of the light emitting elements comprises: a light emitting component; and a light guiding component, wherein the light guiding component is arranged: at a first end, to receive light from the light emitting component; and at a second end, to emit the light so as to project the light onto the mirror. Preferably, each of the light emitting elements comprises a light guiding component.

Preferably, the second end of the light guiding component of the first light emitting element is offset from the second end of the light guiding component of the second light emitting element in a direction aligned with the axis of rotation; and the second end of the light guiding component of the first light emitting element is offset from the second end of the light guiding component of the second light emitting element in a direction perpendicular to the axis of rotation.

Preferably, each of the light emitting elements comprises: a light emitting component; and a light guiding element and/or light guiding component.

According to another aspect of the present disclosure, there is described a display comprising: a mirror arranged to rotate about an axis of rotation; and a plurality of light emitting elements arranged to project light onto the mirror; wherein one or more of the light emitting elements is associated with a light guiding element that is arranged to receive light from the associated light emitting element at a first end and to emit the light at a second end so as to project the light onto the mirror, preferably wherein each of the light emitting elements is associated with a light guiding element.

Preferably, the light guiding elements (and/or components) are arranged to transfer light between the first end and the second end via total internal reflection (TIR).

Preferably, the light guiding elements comprise fibre optic elements.

Preferably, the light guiding elements are at least 50 mm long, at least 100 mm long, and/or at least 1 m long. Preferably, the display comprises a cable that comprises a plurality of light guiding elements. Preferably, the cable further comprises reinforcement.

Preferably, the display comprises a first part and a second part, wherein: the first part comprises the light emitting elements (and/or components); the second part comprises the mirror; and the first part and the second part are connected by the light guiding elements (and/or components).

Preferably, the first part further comprises one or more of: a processor; control electronics; and a cooling element, such as a fan.

Preferably, one or more, or each, of the light guiding elements (and/or components) is associated with a plurality of light emitting elements and/or constituent light emitting elements (and/or components). Preferably, one or more, or each, of the light guiding elements (and/or components) is associated with a plurality of light emitting elements of different types and/or colours.

Preferably, each of the light emitting elements comprises a plurality of constituent light emitting elements (and/or components), wherein each light emitting element comprises a combining structure for combining the light emitted by the constituent light emitting elements before feeding the combined light into a light guiding element (and/or components). Preferably, the combining structure comprises a structure for causing chromatic dispersion. Preferably, the combining structure comprises a prism.

According to another aspect of the present disclosure, there is described a display comprising: a mirror arranged to rotate about an axis of rotation; and a plurality of light emitting elements arranged to project light onto the mirror; wherein each of the light emitting elements comprises a plurality of constituent light emitting elements, wherein each light emitting element comprises a combining structure for combining the light emitted by the constituent light emitting elements before feeding the combined light into a light guiding element, preferably wherein the combining structure comprises a prism.

Preferably, the combining structure is located between the constituent light emitting elements and a/the light guiding element associated with the light emitting element so as to combine the light from the constituent light emitting elements before it reaches a/the first end of the light guiding element.

Preferably, the display comprises a sensor. Preferably, the display comprises one or more of: an orientation sensor; a location sensor; an accelerometer; a magnetometer; a geographical position system (GPS) sensor; an eye-tracking sensor; a head tracking sensor; and a directional sensor.

Preferably, the axis of rotation of the mirror is offset from a central axis of the mirror.

Preferably, the mirror is arranged to oscillate about the axis of rotation.

Preferably, the mirror comprises a square and/or rectangular mirror.

Preferably, the mirror comprises a prism.

Preferably, the display comprises one or more of: a curved mirror, a flexible mirror, and a deformable mirror.

Preferably, the display comprises the mirror is arranged to move translationally relative to the light emitting elements and/or relative to a housing of the display.

According to another aspect of the present disclosure, there is described a display comprising: a mirror arranged to rotate about an axis of rotation; and a plurality of light emitting elements arranged to project light onto the mirror; wherein the mirror is arranged to move translationally relative to the light emitting elements and/or relative to a housing of the display

Preferably, the mirror is arranged to rotate about the axis of rotation as it moves translationally.

Preferably, the mirror is arranged to move along one or more of: a curved path, a parabolic path, and/or a straight path.

Preferably, the display is arranged such that a position of a user of a display, the mirror, and the light emitting elements define an angle (θ) that is at least 15°, at least 30°, and/or at least 60° when the mirror is in a first position at a first end of a path of movement and/or the mirror is in a second position at a second end of a path of movement.

Preferably, the mirror is arranged to rotate by at least 15°, at least 30°, and/or at least 60° as it moves between a first position at a first end of a path of movement and a second position at a second end of a path of movement.

Preferably, the mirror is arranged to rotate by no more than 45°, no more than 30°, and/or no more than 15° as it moves between a first position at a first end of a path of movement and a second position at a second end of a path of movement.

Preferably, the display comprises a movement mechanism for moving the mirror translationally. Preferably, the display comprises a movement mechanism for rotating the mirror.

Preferably, the display comprises a plurality of mirrors. Preferably, each mirror is associated with a different plurality of lighting elements.

Preferably, the display comprises at least 1000 light emitting elements.

Preferably, the light emitting elements are arranged to oscillate.

According to another aspect of the present disclosure, there is described a display comprising: a mirror; and a plurality of light emitting elements arranged to project light onto the mirror; wherein each of the light emitting elements is arranged to vibrate and/or oscillate so as to project a line of light onto the mirror.

Preferably, each of the light emitting elements is associated with a magnet. Preferably, the display comprises a solenoid that is arranged to move the magnets.

Preferably, the light emitting elements comprise light guiding elements, which light guiding elements are arranged to vibrate and/or oscillate. Preferably, the light guiding elements are flexible.

Preferably, each light guiding elements is arranged to (e.g. restrained so as to) move along a line.

Preferably, a first light emitting element and a second light emitting element (and/or a first light guiding element and a second light guiding element) are offset in a direction of emission of light from the light emitting elements, thereby providing a volumetric display.

Preferably, the display comprises a vibrating support, wherein each of the first and second light emitting elements is attached to the vibrating support.

According to another aspect of the present disclosure, there is described a headset comprising the display of any preceding claim.

Preferably, the headset comprises a plurality of displays as aforesaid. Preferably, the headset comprises a display as aforesaid for each eye of a user.

Preferably, the headset comprises and/or is a pair of spectacles (e.g. eyeglasses). Preferably, the mirror comprises a lens of the spectacles.

Preferably, the headset comprises one of more of: a virtual reality (VR) headset; an augmented reality (AR) headset; and a mixed reality (XR) headset.

According to another aspect of the present disclosure, there is described a fixed display comprising the display as aforesaid. Preferably, the display comprises a viewing structure for viewing the display. Preferably, the viewing structure comprises one or more external lenses.

Preferably, the display and/or the fixed display comprises a high-resolution display and/or a display for viewing medical images.

According to another aspect of the present disclosure, there is described a projector comprising the aforesaid display.

Preferably, the projector comprises a projecting lens arranged to receive light reflected from the mirror. Preferably, the projecting lens is arranged to diffuse and/or focus the light.

Preferably, the projector comprises a portable and/or head-mounted projector.

Preferably, the projector comprises a partially reflective mirror arranged so that the light is projected by reflection from the mirror as well as being viewable through the mirror.

Preferably, the projector comprises a screen onto which the light is projected.

According to another aspect of the present disclosure, there is described a system comprising the projector as aforesaid and one or more retroreflective surfaces.

Preferably, the projector is arranged to display one or more virtual objects on the one or more retroreflective surfaces.

According to another aspect of the present disclosure, there is described a method of operating the display of any preceding claim.

Preferably, the method comprises providing an input signal to one or more of the light emitting elements. Preferably, the input signal comprises one or more of: a square wave; a wave with a frequency of at least 10 MHz, 20 MHz, and/or 50 MHz; and a pulse width modulated wave.

Preferably, the method comprises altering the modulation of the wave to alter a brightness of an associated light emitting element.

According to another aspect of the present disclosure, there is described a method of manufacturing the display of any preceding claim.

According to another aspect of the present disclosure, there is described a kit of parts for a display, the kit of parts comprising: a mirror arranged to rotate about an axis of rotation; and a plurality of light emitting elements arranged to project light onto the mirror.

According to another aspect of the present disclosure, there is described a system comprising: a mirror arranged to rotate about an axis of rotation; and a plurality of light emitting elements arranged to project light onto the mirror.

The invention extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

Embodiments of the disclosure are described below, by way of example only, with reference to the accompanying drawings.

### BRIEF DESCRIPTION OF THE DRAWINGS

FIG. 1 illustrates a display based on an oscillating mirror according to the prior art.

FIGS. 2a and 2b describe a method of operating a display based on an oscillating mirror.

FIGS. 3a-3c show effects of altering the duration and frequency of operation of light emitting elements that project light onto an oscillating mirror.

FIGS. 4a and 4b show lighting arrays that comprise a plurality of lines of light emitting elements.

FIG. 5 shows an arrangement of light emitting elements and light guiding elements.

FIG. 6 shows a display that comprises a first part and a second part that are connected by light guiding elements.

FIG. 7 shows an angled lighting array.

FIG. 8 shows a lighting array formed of a plurality of angled sections.

FIG. 9 illustrates a disparity in the brightness of light emitted by a light emitting element.

FIG. 10 shows a lighting array that comprises masks, the masks each being associated with a corresponding light emitting element.

FIG. 11 shows arrangements for combining light from a plurality of constituent light emitting elements that comprises a prism.

FIGS. 12a and 12b shows arrangements for combining light from a plurality of constituent light emitting elements.

FIG. 13 shows a computer device with which the display may be implemented.

FIGS. 14a and 14b show a display that uses a large mirror.

FIGS. 15a and 15b show a display that uses a moveable mirror.

FIGS. 16a and 16b show systems that use a moveable mirror, e.g. the moveable mirror of FIGS. 15a and 15b.

FIG. 17 shows a light guiding element that is arranged to oscillate.

FIG. 18 shows a pair of axially offset light guiding elements.

FIG. 19 shows a system comprising a projector.

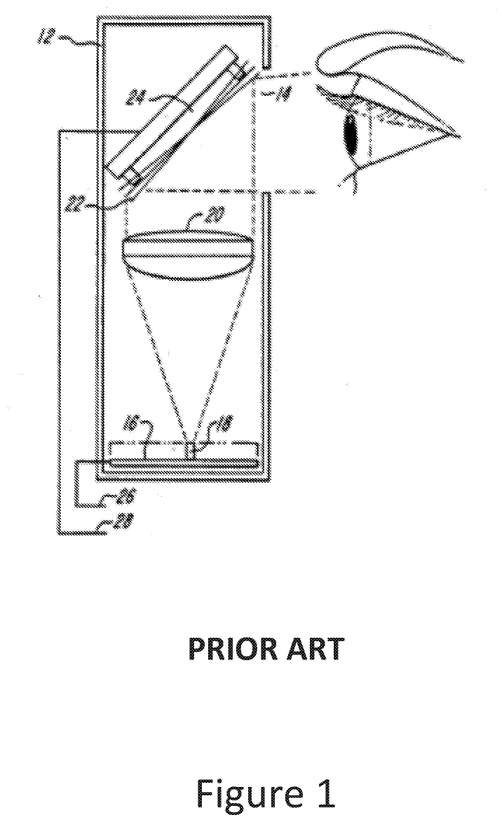

### DETAILED DESCRIPTION OF THE EMBODIMENTS

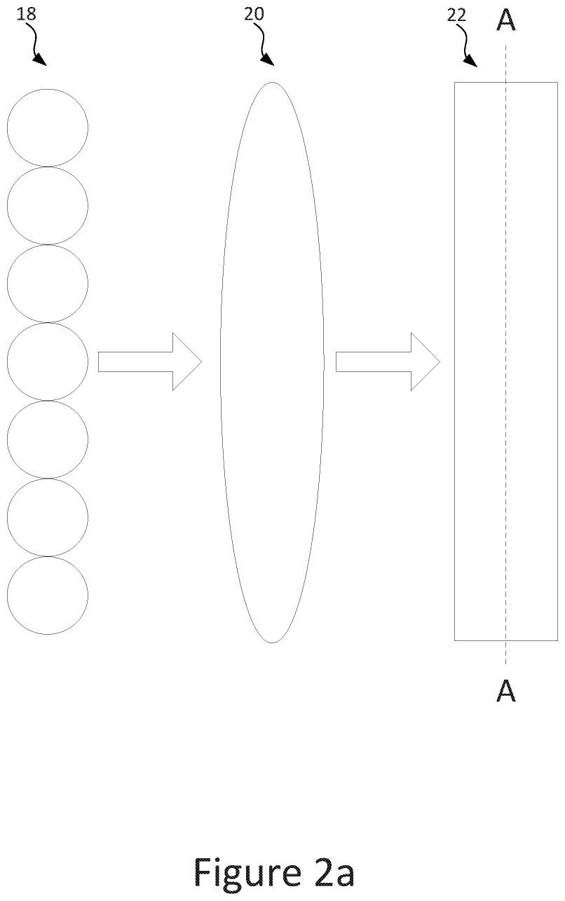

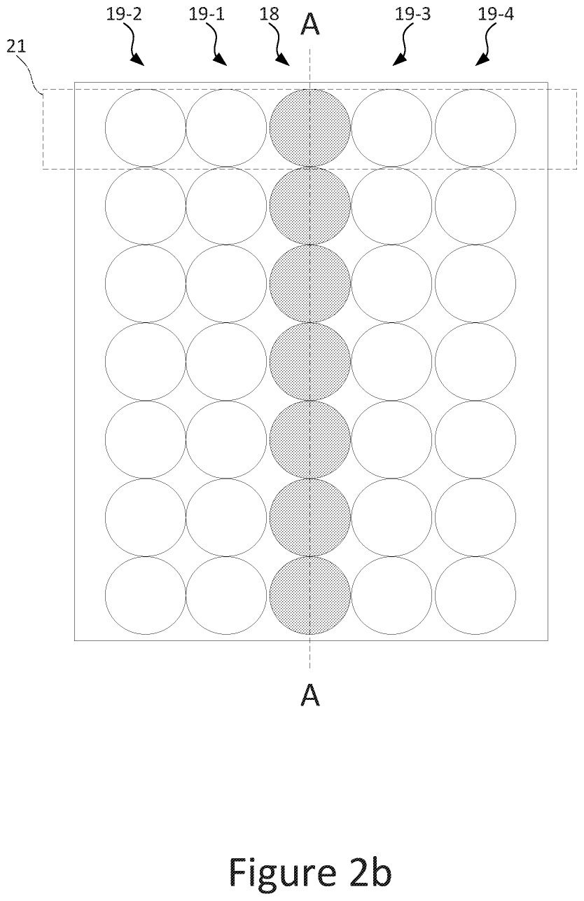

Referring to FIGS. 2a and 2b, a method of operating of a display based on an oscillating mirror is described.

As has been described in the background above, a display can be provided by arranging a line 18 of light emitting elements adjacent a collimating lens 20 and a mirror 22 so that light emitted by the light emitting elements passes through the collimating lens and is projected onto the mirror. The mirror is arranged to oscillate about an axis of rotation AA—and the light emitting elements are arranged along an axis that is (at least partially) aligned with the axis AA about which the mirror oscillates. Each of the light emitting elements causes a row of light to be displayed on the mirror so that an image is visible to a user observing the mirror.

Referring to FIG. 2b, there is shown an example in which the line of light emitting elements is arranged to project light along the centreline of the mirror 22 (e.g. along the axis AA of the mirror) when the mirror is in a starting position. As the mirror oscillates about the axis AA, the points onto which the light emitting elements project light change. Therefore, each of the light emitting elements becomes associated with a row of pixels (a ‘scan row’). A first row 21 of pixels is identified in FIG. 2b, where this row of pixels is associated with the uppermost light emitting element of the line 18 of light emitting elements.

If a light emitting element was left on continuously, the oscillation of the mirror would cause a smear of light along the row associated with that light emitting element so that instead of being associated with a number of separate pixels, the light emitting element would be associated with a single elongated oval of light. In order to project individual pixels onto the mirror, each light emitting element is operated (e.g. switched on and off) at a high frequency. The frequency of operation of the light emitting elements (the rate at which the elements are switched on and off) and the duration of operation of the light emitting elements (the length of time for which the elements are left on) typically depends on the oscillation frequency of the mirror, where differing resolutions can be obtained by altering these operational parameters; for example, to obtain a resolution of 1024 pixels per line, the light emitting elements are (capable of being) turned on and off 1024 times during each oscillation of the mirror. These operational parameters may also be altered by a user and/or an application that is using the display.

The light emitting elements being operated at a high frequency may comprise the light emitting elements remaining on or remaining off for an extended period of time. The light emitting elements being operated at a high frequency thus refers to the light emitting elements being controllable so as to be switched on or off at a high frequency, where the status of the light emitting elements at each time depends on the image being shown. To obtain a horizontal fill factor of 100%, each of the light emitting elements is typically capable of being operated at a duty cycle of 100% (e.g. each of the light emitting elements can typically be operated so as to continuously on so that there is no gap between the pixels associated with that light emitting element and a continuous line of light is projected onto the mirror).

The frequency of operation of the light emitting elements is typically equal to fₑₗₑₘₑₙₜₛ=Nₚᵢₓₑₗₛ*fₘᵢᵣᵣₒᵣ*2, where Nₚᵢₓₑₗₛ is the desired number of pixels in a row (e.g. the desired horizontal resolution of the display) and fₘᵢᵣᵣₒᵣ is the oscillation frequency of the mirror. Therefore, for a mirror with an oscillation frequency of 30 Hz and a desired horizontal resolution of 1000 pixels, the light emitting elements are operated at a frequency of 72 KHz. In some embodiments, a factor is included within the above equation to account for mirror reversal/overscan—and the above example includes a factor of 1.2 for mirror reversal/overscan.

Typically, the mirror is arranged to oscillate at one or more of: at least 20 Hz, at least 30 Hz, at least 50 Hz, at least 60 Hz, at least 90 Hz, at least 100 Hz, at least 200 Hz, and/or at least 500 Hz. To obtain high resolutions, the light emitting elements may be operated at a frequency of one or more of: at least 50 kHz, at least 100 kHz, and/or at least 150 KHz.

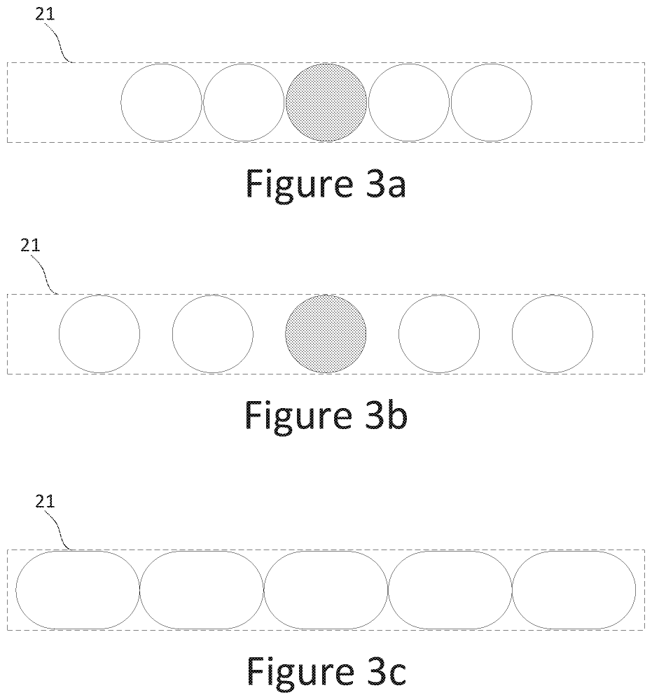

Referring to FIG. 3a, typically the frequency and the duration of operation of the light emitting elements are selected so as to obtain regularly shaped pixels that are closely spaced (e.g. so there is a 100%, or near 100%, fill factor in the row associated with each of the light emitting elements). However, in certain embodiments it may be desirable to alter the shape or spacing of the pixels by altering the operational parameters. For example, referring to FIG. 3b, by reducing the duty cycle of an input signal of the light emitting elements the fill factor of the row can be decreased and spaces appear between the pixels in the row; equally, referring to FIG. 3c, by increasing the duration of operation of the lighting elements the pixels become elongated as the light emitting elements remain on for a substantial duration as the oscillation of the mirror causes the point at which light is projected to change.

To control the brightness of each pixel, the light emitting elements may be operated (e.g. turned on and off) during a scan period in a manner comparable to the operation of a dimmer switch. Therefore, the input signal for the light emitting elements may comprise a combination of (e.g. a convolution of or a multiplication of) a first relatively low frequency input signal that is associated with the provision of pixels of a suitable size and a second relatively high frequency input signal that is used to control the brightness of the pixels. For example, the high frequency input signal may have a frequency that is at least 5 times that of the low frequency input signal and/or at least 10 times that of the low input frequency signal.

In various embodiments, the input signal may have a frequency of at least 10 MHz, at least 20 MHz, and/or at least 50 MHz to enable the provision of various brightnesses of pixel. The input signal typically comprises a pulse width modulated signal. Typically, the input signal is arranged to be a regular signal during the ‘on’ cycle of the associated light emitting element; for example, to provide a pixel with 50% of maximum brightness, a regular square wave may be provided with a duty cycle of 50%.

In a more specific example, a pixel clock of 100 Khz is considered so that the scan time for each pixel cell is 10 microseconds. To provide 256 possible levels of brightness, an input signal with a pulse width modulation frequency of 25.6 MHz is required. This enables each 10 microsecond cell to be split into 256 separate timeslots with the light emitting element being turned on for as many timeslots as needed to achieve the desired brightness/pixel intensity.

As is described further below, the present disclosure considers an embodiment in which the light emitting elements are rectangular. Such light emitting elements may be used to create square pixels (since the pixels become elongated on the mirror as the mirror oscillates. In a practical example, to create a square pixel with a rectangular light emitting element that has an aspect ratio of 1:3, the light emitting element should have a duration of operation that is three times as long as the time taken for the mirror to scan the actual width of the light emitting element (where this time depends on the dimensions of the light emitting element and the placement/frequency of oscillation of the mirror).

### Mirror Oscillation

Regarding the frequency of oscillation of the mirror 22, even a relatively slow frequency of oscillation (10 Hz or even below) is typically sufficient to create legible text and/or to show a recognisable image; however, using a low frequency of oscillation can result in visible flickering. Therefore, typically the mirror is oscillated at a high frequency to obtain an image that appears to be steady. Since the mirror is oscillating an image can be projected on both the forward and backward sweeps and therefore the refresh rate of the image is twice the mirror frequency (e.g. an oscillation frequency of 36 Hz causes a refresh rate of 72 Hz). Human vision typically perceives flicker below refresh rates of 60 to 72 Hz; therefore, to avoid flickering (or the possibility of flickering) the oscillation frequency of the mirror is typically at least 30 Hz, at least 36 Hz, at least 50 Hz, at least 100 Hz, and/or at least 200 Hz.

In some embodiments, the mirror 22 is attached to a vibrating element via a spring flexure which is resonant at a desired oscillation frequency. Such an arrangement requires very little drive power to generate the oscillation of the mirror; for example, the mirror may be driven using a power of only a few milliwatts. This enables the use of a small power source so that a portable and/or lightweight display can be provided (e.g. where the light emitting elements and/or the vibrating element are powered with a battery).

In some embodiments, a lens (and/or an array of lenses and/or a microlens array) is located between the light emitting elements and the mirror. Such a lens can provide magnification and adjustable focus. Both simpler and more complex optical arrangements are possible; for example, the lens can be omitted entirely if the optical path to the array is long enough for the eye to accommodate or if the lens is integrated into a pair of spectacles (e.g. as a small viewing lens in the larger spectacle lens).

In some embodiments, the display comprises multiple optical elements, such as additional lenses, mirrors and prisms to increase the field of view. For example, in some embodiments the display comprises a static curved mirror located in front of one or both eyes to magnify the scan range and so increase the field of view). The display may comprise a lens and/or a plurality of lenses between the mirror 20 and the output of the display (e.g. the location at which the user is able to place their eyes).

In some embodiments, and in particular with augmented reality (AR) and mixed reality (XR) designs, the display may be arranged so that the optical path of the light emitted by the light emitting elements comprises semi-transparent (e.g. ‘half-silvered’) mirrors to allow the display of information on top of the normal field of view. Such mirrors enable the use of the headset in a range of situations, from simple information-style head-up displays to dynamic overlays which add overlays and virtual objects that interact with the real-world view.

The display typically comprises two separate arrays of light emitting elements and separate scan mirrors for each eye. In some embodiments, a single array of light emitting elements is provided which is scanned to each eye in turn, for example to a left eye on the forward sweep of the mirror and to a right eye on the backward sweep. Similarly, a single array may be combined with a rotating prism and/or a polygonal mirror to generate an image and provide this to a desired eye. Similarly, there may be provided a headset with a plurality of displays (e.g. a display for each eye), where each display comprises an oscillating mirror and a plurality of light emitting elements.

In some embodiments, the display comprises a mirror galvanometer that is arranged to deflect a light beam with a mirror in response to the provision of an electric current. Mirror galvanometers enable fast, and controlled, mirror movement and allow for continuously variable refresh rates up to several hundred Hertz (with a scan range that typically decreases at the higher frequencies).

### Lighting Array

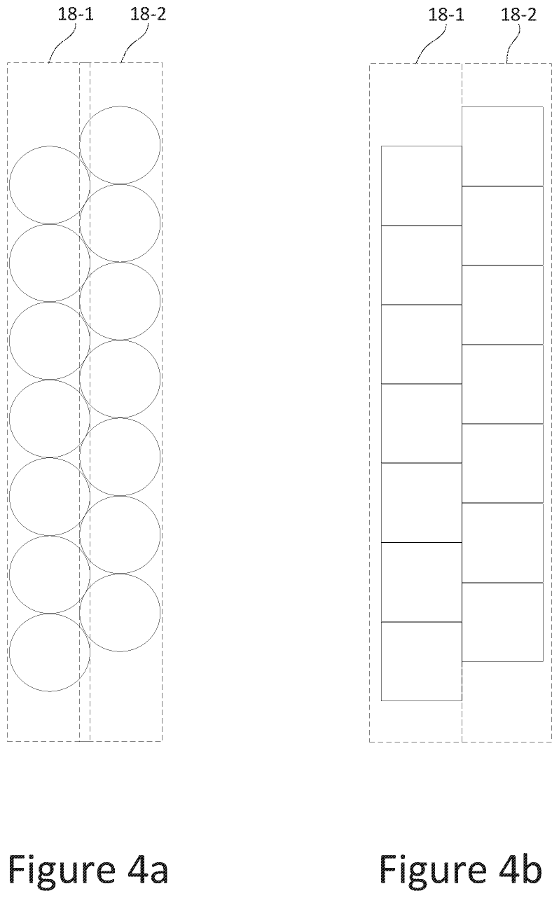

Referring to FIGS. 4a and 4b, there is shown a lighting array for use with a display according to the present disclosure. The array comprises a first line 18-1 of light emitting elements and a second line 18-2 of light emitting elements, where the first line and the second line are offset (and/or staggered). Typically, the light emitting elements are each of the same size (and/or the same type), and the offset between the lines is equal to the radius of the light emitting elements.

The light emitting elements of the first lines 18-1 and the second line 18-2 of light emitting elements are typically each arranged along an axis, where these axes are aligned and where the first line and the second line of light emitting elements are offset in the direction of these aligned axis. The first line and the second line are typically also offset in a direction perpendicular to the axis. The lighting array is typically a two-dimensional array, so that the first line and the second line are located on a shared plane.

In the example of FIG. 4a, the lighting array is formed using circular light emitting elements. It will be appreciated that other shapes of light emitting elements may be used, and FIG. 4b shows an embodiment of the lighting array that uses square light emitting elements. A benefit of using circular elements is that when two lines of circular elements are pushed together they will tend to form a staggered position, so that the array can be formed in a straightforward manner.

With the display of the prior art, which comprises a single line of light emitting elements, the vibrating mirror enables the provision of a display with a high fill factor for each row; however, there are still gaps between the light emitting elements in the line of elements, so that the fill factor for the columns is substantially less than 100%. By using a staggered array of light emitting elements, the gaps between the elements of the first row are filled by light from the elements of the second row so that a substantially higher columnar fill factor can be achieved as compared to where a single line of elements is used.

It will be appreciated that more than two lines 18-1, 18-2 of light emitting elements may be used; for example, the display may comprise more than two rows, more than five rows, and/or more than ten rows. An embodiment with more than two rows may be useful where multiple types of elements are used; for example, the lighting array may comprise at least two rows of red LEDs, at least two rows of green LEDs, and at least two rows of blue LEDs, where each pair of rows is offset. With such embodiments, the lighting array may comprise a first line of each type of light emitting element, where these first lines may be aligned, and a second line of each type of light emitting elements, where these second lines may be aligned (with the second lines being offset from the first lines).

The lighting array of FIGS. 4a and 4b may be considered to comprise a plurality of rows of light emitting elements and a plurality of columns of light emitting elements. The examples of FIGS. 4a and 4b have two vertically offset columns of light emitting elements with each column comprising a plurality of light emitting elements. It will be appreciated that the orientation may be altered so that the lighting array may comprise two (or more) offset rows of light emitting elements with each row comprising a plurality of light emitting elements.

The lighting array of FIGS. 4a and 4b leads to two lines 18-1, 18-2 of light emitting elements that are both horizontally offset and vertically offset. To provide an image, the lines of light emitting elements are operated separately. During operation, the horizontal offset may be compensated for by slightly adjusting the timing of the lighting signals used to drive the columns of light emitting elements, such that the lighting signals for the trailing column is delayed so that it is output when the mirror has travelled the additional distance required to make the trailing column appear to be in the same position as the leading column.

Putting a second line 18-2 of light emitting elements alongside a first line 18-1 of light emitting elements, with the two lines being offset vertically by the spacing of the light emitting elements enables the provision of a display with a 100% fill factor (since the second line fills in the gaps of the first line) albeit with alternating rows offset by the horizontal spacing of the two light-emitting columns. It will be appreciated that this concept can be extended to more than 2 lines, which is relevant to making a full colour display (using a combination of blue, red and green LED arrays, for example).

In this regard, typically the lighting array comprises at least one line of blue light emitting elements and/or at least one line of red light emitting elements and/or at least one line of green light emitting elements. In some embodiments, the lighting array comprises at least at least two lines of blue light emitting elements and/or at least two lines of red light emitting elements and/or at least two lines of green light emitting elements, wherein the lines of each colour of light emitting elements are offset so as to obtain a 100% fill factor for each colour.

In some embodiments, one or more of (or each of) the light emitting elements comprises a plurality of constituent light emitting elements. For example, each light emitting element may comprise a red constituent light emitting element, a green constituent light emitting element, and a blue constituent light emitting element. There may then be provided a lighting array as shown in FIGS. 4a and 4b in which each of the light emitting elements is capable of outputting any colour of light so that an array with two lines of light emitting elements is capable of outputting a colour image.

In some embodiments, the lighting array is arranged such that each of the light emitting elements has a 50% vertical fill factor. In some embodiments, the lighting array is arranged such that there is no overlap between the light emitted by light emitting elements in adjacent lines. This leads to an array in which each line of light emitting elements can operate independently (since there is no overlap of the light emitted by these elements). This may comprise spacing the light emitting elements in each of the lines 18-1, 18-2 (e.g. so that within each line there is a gap between adjacent light emitting elements. Equally, the lighting array may be arranged such that there is some overlap between the light emitted by the two lines of light emitting elements. In embodiments with overlapping light emitting elements located in two lines this may lead to areas of differing light intensity on the display. This may be addressed by providing further lines of light emitting elements so that there is the same amount of light emitted in each ‘row’ of the array.

### Light Guiding Elements

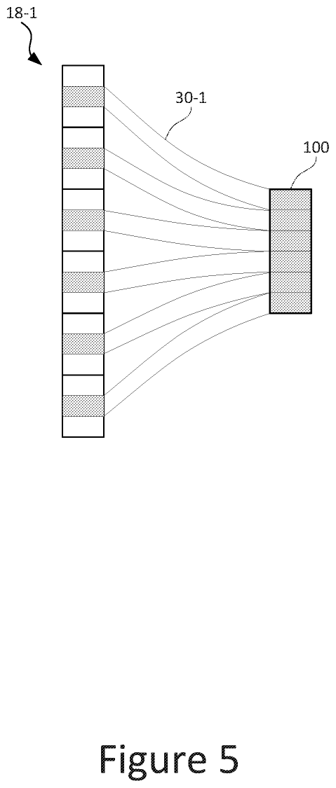

Referring to FIG. 5, in order to implement aspects of the present disclosure, there may be provided a display in which light from the light emitting elements is provided to a headset using light guiding elements. More specifically, the headset may comprise at least one light guiding element where a first (input) end of the light guiding element is located adjacent a light emitting element such that light from the light emitting element is output from a second (output) end of the light guiding element.

Typically, the light guiding elements comprise fibre optic elements that are arranged to transfer light between two ends of the element via total internal reflection (TIR). Equally, the light guiding elements may comprise a light guide (or indeed any other structure that is capable of transferring light between two points).

Since each light emitting element has a minimum width, providing a plurality of lines of light emitting elements can create a headset that is bulky and impractical. Furthermore, it can be difficult to closely mount light emitting elements so as to obtain a high-resolution lighting array. By using light guiding elements, it is possible to provide a display with small gaps between the light output by the light emitting elements.

FIG. 5 shows the first line 18-1 of light emitting elements being connected to a display 100 using a plurality of light guiding elements 30-1. FIG. 5 shows an (exaggerated) view of a first line 18-1 of light emitting elements in which each light emitting element comprises a light portion surrounded by a dark portion (which dark portion contains e.g. control and power connections). Using the light guiding elements, the light output by the light portion of the light emitting elements can be transferred to the display via the light guiding elements. As shown in FIG. 5, the light guiding elements do not require control and power connections so can be closely packed to avoid any gaps between the light emitted by the light guiding elements.

This enables an increase in the fill factor of a display even in embodiments with only a single line of light emitting elements (and the present disclosure envisages the provision of a display with a single line of light emitting elements that is associated with light guiding elements). Since the light guiding elements still have some width, staggered lines of light emitting elements may be provided—as described with reference to FIGS. 4a and 4b—to achieve a further increase in the fill factor.

Furthermore, by using light guiding elements, the light emitting elements can be spaced from the remainder of the display while the light provided by these elements is still provided to the oscillating mirror. Typically, the light guiding elements are flexible to aid in the installation and position of these elements.

The light guiding elements are typically of light weight (e.g. the light guiding elements may be fibre optic cables) and can therefore be of substantial length without being unwieldy. For example, the light guiding elements may be at least 50 mm long, at least 100 mm long, at least 1 m long, at least 5 m long, and/or at least 10 m long. The length may depend on the intended use of the display so that, for example, a display for a portable headset may be provided with relatively short guiding elements (e.g. that lead from the front of a pair of glasses to the rear of the same pair of glasses). Equally, the display may be used with the guiding elements that are of a long length; such an embodiment may be used where the display is intended for use within a specific environment or room. This can enable a user to put on a lightweight headset that can be used within the environment where a main unit (with processors, control electronics, lighting emitting elements, cooling fans, etc.) that is bulky, hot, and/or noisy is spaced from a user and the light guiding elements deliver light from this main unit to the lightweight headset. Such an embodiment is of particular use where high resolution images are being displayed and/or complex processing is occurring (e.g. so that a user can play video games).

Typically, each of the light emitting element is associated with a corresponding light guiding element (as shown in FIG. 5). For example a plurality of LEDs may each be associated with a separate fibre optic cable.

The light emitting elements being associated with light guiding elements may be considered to relate to each of the light emitting elements comprising a light guiding element. In this regard, the light emitting elements may be composed of light emitting components (e.g. light emitting diodes) and light guiding components (e.g. the light guiding elements) so that the provision of a lighting array of light emitting components may comprise the provision of an array of light emitting components (e.g. LEDs arranged in offset lines) and/or the provision of an array of light guiding components (e.g. light guiding elements arranged in offset lines, where the light emitting components may then be arranged in any structure).

While FIG. 5 shows an arrangement in which a line of light emitting elements feeds light to a similarly arranged array of output ends of light guiding elements; it will be appreciated that alternate arrangements are possible (e.g. the light guiding elements may be arranged to feed light from a 8×8 array of LEDs/first ends to a 32×2 array of second ends). The second, output, end of each light guiding element may be considered to itself be a light emitting elements, so that light guiding elements may be used to form a lighting array as described with reference to FIGS. 4a and 4b, where the ‘light emitting elements’ of the lighting array are the output ends of the light guiding elements and where these output ends are arranged to form staggered lines of light emitting elements.

The light guiding elements are arranged to provide light to the lens 20 (in embodiments where a lens is used) and thereafter to the mirror 22. The display typically comprises a first part (e.g. the main unit) that comprises the light emitting elements (and, for example, the processor etc.) and a second part that comprises the mirror (and, optionally, the lens). The light guiding elements connect the first part and the second part of the display. The second part may comprise further componentry such as sensors; for example, the second part may comprise head tracking sensors and/or a camera to enable passthrough of external images to the user.

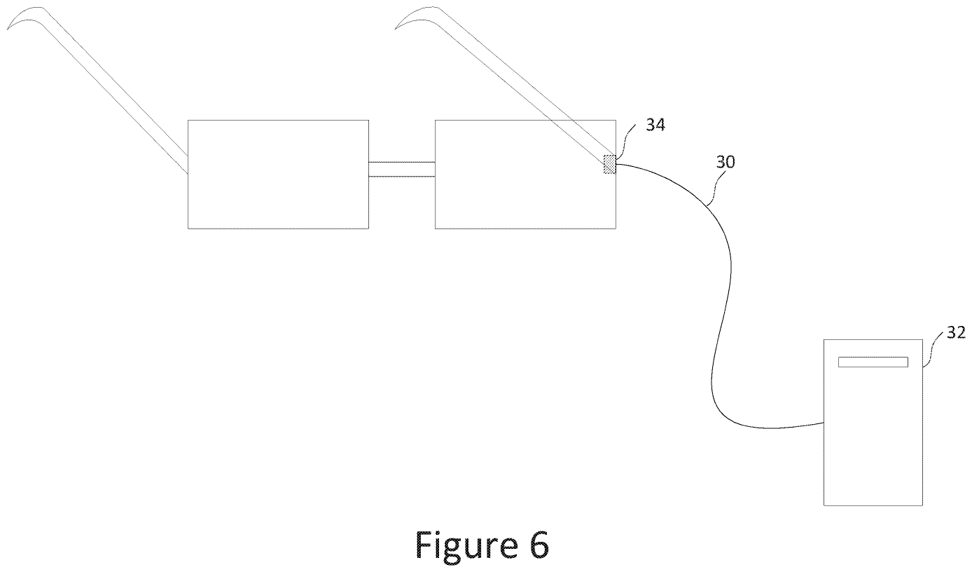

Referring to FIG. 6, there is shown an exemplary embodiment of the display that comprises a first part 32 and a second part 34 connected by a light guiding part 30 (which typically comprises a plurality of light guiding elements). The light guiding part may comprise an attachment mechanism to attach it to the headset, e.g. to attach the light guiding part to a temple of a pair of augmented reality glasses.

The first part 32 may comprise a computer device.

Typically, the display is provided with the first part 32 and the second part 34. The present disclosure further considers embodiments in which only the second part is provided and/or in which the second part and the guiding elements are provided. This first part may then be connected by a user to their computer device.

In some embodiments, the display is provided with a ‘lightweight’ second part that comprises the light emitting elements, but comprises no (or only a low-powered) processor etc. Such a display may then be plugged into another computer device, which other computer device comprises a more powerful processor that is able to output an image to the display.

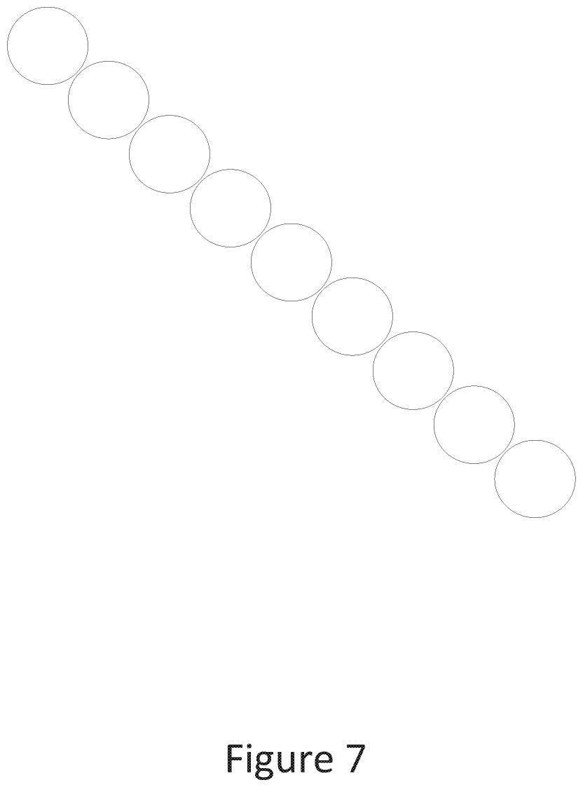

Referring to FIG. 7, there is shown an angled lighting array that may be used with a display according to the present disclosure.

As well as by providing multiple linear arrays (as described with reference to FIGS. 4a and 4b), it is also possible to achieve a large fill factor by tilting a single array so that its axis is no longer orthogonal to the axis about which the mirror oscillates (the ‘scan direction’).

With an angled lighting array, an image can still be projected onto the mirror by adjusting the operation of each light emitting element according to the delay necessary to compensate for the angle of the lighting array. The angle enables a reduction in the vertical separation between light emitting elements without changing their apparent size. This enables high fill factors to be achieved. The angle required to obtain a fill factor of 100% depends on the fill factor of the elements when located a straight line, where light emitting elements with comparatively large dark portions require a comparatively large angle (as compared to light emitting elements with smaller dark portions)

Typically, angled arrays require additional light emitting elements as compared to straight arrays (since they have a smaller vertical separation between light emitting elements.

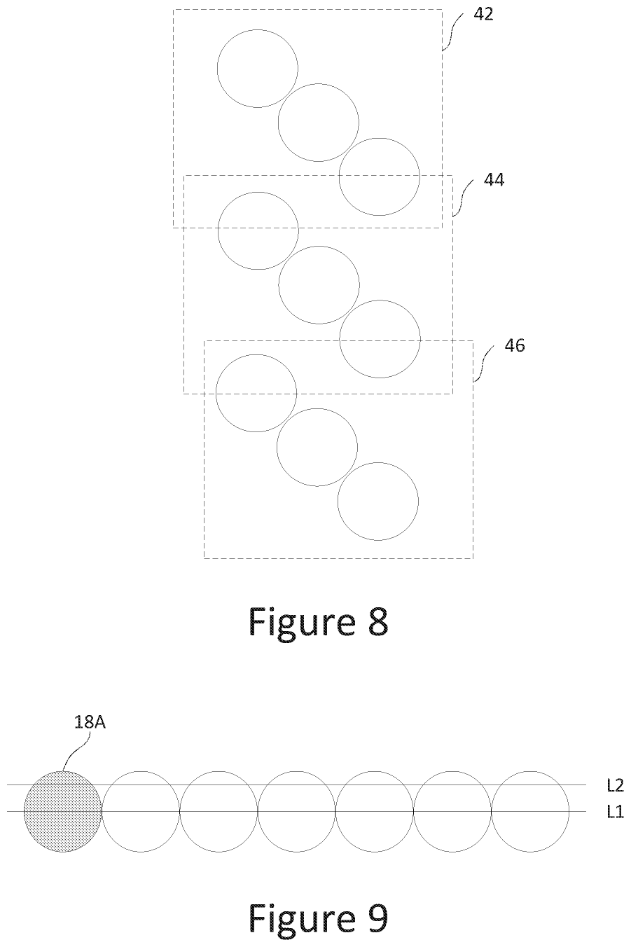

Angled arrays enable high vertical fill factors to be achieved at the cost of an increased width of the lighting array. Referring to FIG. 8, in order to reduce the width of an angled lighting array, the lighting array may be divided into a plurality of sections 42, 44, 46, where each section comprises a plurality of light emitting elements arranged in an angled formation. The vertically spaced sections shown in FIG. 8 may be aligned in the horizontal direction (and it will be appreciated that equally a plurality of horizontally spaced sections may be aligned in a vertical direction). Each section comprises a plurality of light emitting elements extending in each of a first direction and a second direction from a first light emitting element to a final light emitting element, where the first direction and the second direction are perpendicular.

Typically, the arrangement and/or the angle of the light emitting elements in each section is the same, but it will be appreciated that the arrangement/angle of light emitting elements in each section may differ.

It is noted that the embodiments described with reference to FIGS. 4a and 4b are examples of sectional angled formations, where these embodiments of FIGS. 4a and 4b comprise a plurality of angled sections each having two light emitting elements.

In general, there is disclosed a lighting array in which at least two light emitting elements are spaced in each of a first direction and a second direction, the second direction being perpendicular to the first direction, where the first direction is aligned with an axis of an oscillating mirror, and wherein the spacing of the light emitting elements in at least one direction is less than a diameter of (at least one of) the light emitting elements.

### Pixel Shape

There is further considered herein a system that accounts for the pixel shape provided by each of the light emitting elements and the effect that this has on the quality of the display. In this regard, a “perfect” display would appear totally uniform when set to display a single colour with no gaps, seams or brightness variations. As has been described above, lighting arrays may be provided where each line (e.g. each vertical line) of the lighting array has a 50% fill factor and each light emitting element provides a row (e.g. a horizontal line) with a 100% fill factor in order to obtain such a uniform brightness.

The quality of the display may also depend on the shape of the light emitting elements. This can be explained with reference towards a simple example in which a single light emitting element 18A is used to form a row of an image. Where the light emitting element is of circular shape, then each ‘pixel’ of the row will similarly be of circular shape. The frequency at which the light emitting element is operated is typically chosen so that the pixels formed by the light emitting element have no gaps between them as shown in FIG. 9; this image shows a row of pixels that is formed on the oscillating mirror 20 as the light emitting element 18A is operated (e.g. turned on and off).

FIG. 9 shows two lines L1 and L2 associated with the light emitting element 18A, where a first line L1 is located at the center of the row of pixels and a second line L2 is located near the edge of the row of pixels. Where circular light emitting elements are used, the first line L1 at the centre of the scan row will typically be brighter than the second line L2 nearer the edge of the scan row because the first line L1 at the centre of the row is formed by touching pixels whereas the second line L2 is located nearer the edges of the light emitting element where there are spaces between ‘pixels’. Therefore, when using circular light emitting elements, even in displays with a 100% vertical fill factor, there may be a noticeable difference in brightness between the rows of an image. Similarly, when providing a 100% horizontal fill factor with circular light emitting elements there may be a noticeable difference in the brightness of columns of an image.

The spacing between the pixels associated with a light emitting element is dependent on the frequency with which the light emitting element is operated, so that the spaces between the edges of pixels could be eliminated by operating the light emitting element at a higher frequency. However, this would cause an overlap between adjacent pixels.

Furthermore, the shape of each pixel is dependent on the duration of operation of each light emitting element. With circular light emitting elements, increasing the duration of operation of the light emitting elements leads to oval pixels (e.g. as shown in FIG. 3c). To obtain circular pixels, the duration of operation for each pixel is typically short; to obtain touching (or closely spaced pixels), the frequency of operation, and the maximum obtainable duty cycle, of each pixel is typically high. The values of the duration of operation and the frequency of operation may be varied in dependence on the oscillation frequency of the mirror and based on the desired pixel spacing/shape. These values may be varied between uses of the display or may even be varied during a single use (e.g. a user may be able to vary the time or frequency of oscillation to achieve reduced energy usage, or increased intensity).

In some embodiments, the duration of operation of each element is selected so as to reduce the variation in brightness along a line of pixels. In this regard, as described above, increasing the duration of operation for a circular light emitting element leads to the pixels associated with that element appearing as elongated ovals, and this can help to reduce the brightness variation along a row of pixels that is caused by the pixel shape (since the variation of pixel height occurs at the start and end of pixels). However, even where the light emitting elements are operated in such a manner, there is still a difference in intensity/brightness between the centre of each pixel and the extremities of that pixel (since at any one instance the width of light—and thus the amount of light—emitted by a line passing through the centre of a circular light emitting element will be greater than the width of light emitted by a line passing through the extremities of that light emitting element).

To reduce this variation in brightness between the extremities and the centre of each pixel, the light emitting elements may be arranged to produce pixels of a similar or constant width/height, for example by providing light emitting elements of a square or rectangular shape- and the present disclosure envisages the provision of a lighting array that uses such light emitting elements. Equally, the lighting array may comprise a tessellation and/or may be formed of tessellating shapes (for example the first line 18-1 may comprise square light emitting elements with the second line 18-2 comprising octagonal light emitting elements.

Since the scan spreads the emitter shape out horizontally (e.g. so that circular light emitting elements appear as elongated ovals), it is possible to achieve perfectly square pixels by starting with narrow vertical rectangular light emitting elements and then setting the duration of operation of these elements emitters so that the pixels formed are of a square shape. The duration of operation required to achieve such square pixels depends on the oscillation frequency of the mirror and on the dimensions of the light emitting elements.

In some embodiments, the display is arranged to provide a pixel fill ratio of greater than 100%, for example by providing a plurality of lines 18-1, 18-2 of light emitting elements such that the pixels formed from light emitting elements of different lines overlap; for example, the lighting array may comprise three lines that each have a 50% vertical fill, where the lines are offset by 33% of the height of a pixel. This causes an overlap between pixels in the vertical direction.

In operation, this can lead to undesirable effects on the display; for example, where each of the lines of light emitting elements is associated with a different colour of pixels (e.g. red, green, blue), then there will be an overlap between red pixels and blue pixels so that this overlap will appear purple.

This negative effect can be addressed by placing a filter and/or mask (e.g. a photolithographic mask) over the emitters, which blocks light from overlapping areas and allows light through in a desired pixel shape. This achieves a similar effect to providing tessellating light emitting elements, but at a reduced cost. In this regard, providing light emitting elements of a desired (e.g. rectangular) shape is typically more expensive/difficult than providing light emitting elements of another (e.g. circular) shape and then placing a (e.g. rectangular) mask on these light emitting elements.

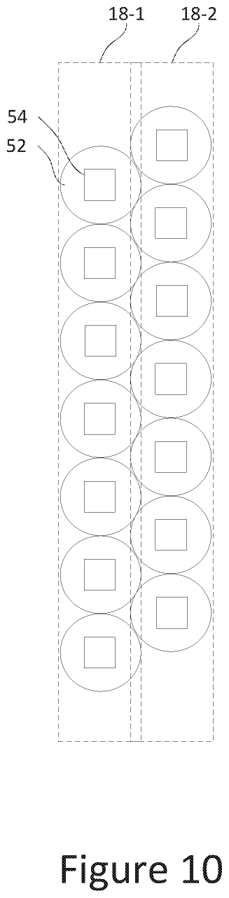

FIG. 10 shows an embodiment of a lighting array of circular light emitting elements in which each of the light emitting elements is associated with a mask 52 that blocks the emission of light from a portion of the light emitting element. Light is still able to pass through an aperture 54 of each mask.

Such masks can be used to provide high fill factors and high quality images with a range of shapes of light emitting elements.

Typically, each mask comprises a rectangular and/or square mask that block all light that impacts the mask outside of the aperture. It will be appreciated that masks of various shapes and/or types may be provided. For example, masks may be provided that block only a certain colour of light and/or masks may be provided that block only a portion of the light emitted by a light emitting element.

Considering another example of the use of masks; where an angled line of rectangular light emitting elements is provided this can result in a variation in intra-line brightness due to the overlap of light emitting elements. A combination of enough angle to overfill the pixel rows combined with a square or rectangular mask can be used to create rows with constant brightness.

### Light Guide Coupling

For maximum efficiency and maximum brightness of the display, the first (input) side of each light guiding element should be arranged to capture the maximum amount of light emitted by an associated light emitting element. Furthermore, the output spread of the light emitting element should be matched to the numerical aperture of the light guiding element (the numerical aperture being the sine of the largest angle an incident ray can have for total internal reflectance in the core of the light guiding element).

However, in simple embodiments, the light guiding elements may simply be positioned above the centre of the light emitting elements; this results in an amount of light being lost but can still provide a visible image even in daylight.

In some embodiments, in order to increase the amount of light that passes through the light guiding elements, the light emitting elements and the light guiding elements are provided as combined components that are arranged to channel as much of the light emitted by the light emitting element as possible into the light guiding element.

In some embodiments, a molded lens system is used, where the relatively wide angle emission for a typical light emitting diode die is reduced to a smaller angle for efficient coupling with a light guiding element. A challenge here is that RGB LEDs typically consist of separate dies for the red, blue and green components and the spatial separation of these dies (even within a single combined RGB LED) is large enough to make it difficult to couple all colours equally effectively. In particular, positioning of the light guiding element above the LED has a substantial effect

In some embodiments, each of the light emitting elements comprises a combination of component emitting elements. For example, each light emitting element may comprise separate red, green and blue constituent light emitting elements. With such embodiments, there may be a light guiding element provided for each of the constituent light emitting elements, or a single light guiding element may be used for each of the light emitting elements.

Where each light emitting element comprises constituent light emitting elements, ideally the constituent light emitting elements (e.g. separate red, green, and blue LEDs) would be located as close together as possible (e.g. on the same die). However, as mentioned above, combined RGB LEDs are typically provided as three separate dies that are packaged together, but are otherwise independent so that there is typically a substantial separation between the constituent light emitting elements.

The different wavelengths associated with each colour cause the light projected by the constituent light emitting elements to refract differently when this light is passed through a prism. Therefore, the component light emitting diodes may be arranged adjacent a prism that is arranged to receive the light projected from each of the constituent light emitting elements and to combine this light. The combined light may then be provided to a light guiding element associated with the light emitting element (which light emitting element comprises the constituent light emitting elements).

It will be appreciated that structures other than prisms may be used to combine the light projected by the constituent light emitting elements. More generally, the display may comprise an optical component that is arranged to combine the light from the constituent light emitting elements (e.g. an optical component with chromatic dispersion).

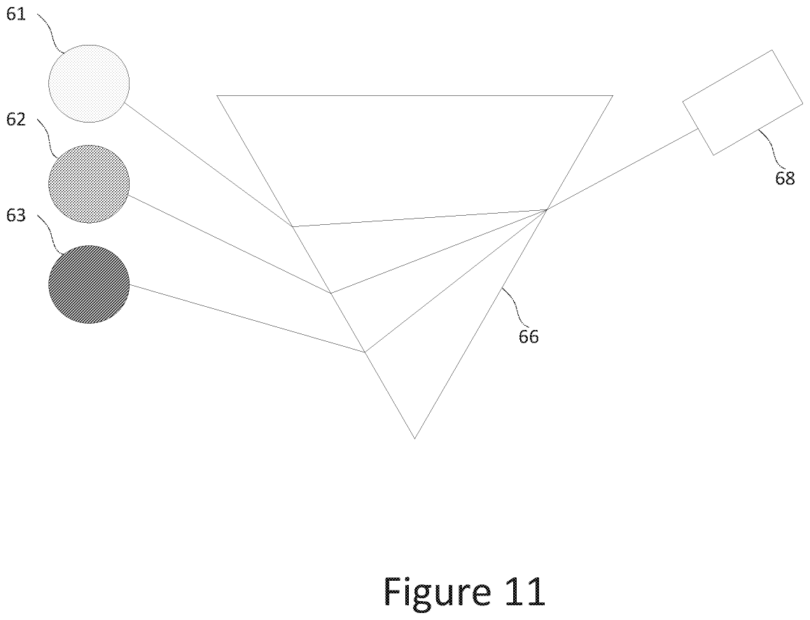

In an illustrative example that is shown in FIG. 11, a linear arrangement comprising a red LED 61, a green LED 62, and a blue LED 63 is located adjacent a prism 66 that receives the light projected by the LEDs on a first side and refracts the light such that the light from each LED is projected from the same location on a second side of the prism. This projected light may then be fed into a light guiding element 68.

Since red light has a larger wavelength than green light, it has a smaller refractive index and so the angle of refraction is less for the red LED 61 than for the green LED 62 and less for the green LED than for the blue LED 63. Therefore, by appropriate placement of the prism 66, it is possible to combine the light emitted by each LED.

The location of the prism, and in particular the appropriate spacing of the prism from the LEDs is dependent on the arrangement of the LEDs. Equations for determining the refraction of light through a prism (based on the wavelength of that light) and thereby determining an appropriate location of the prism are known in the art.

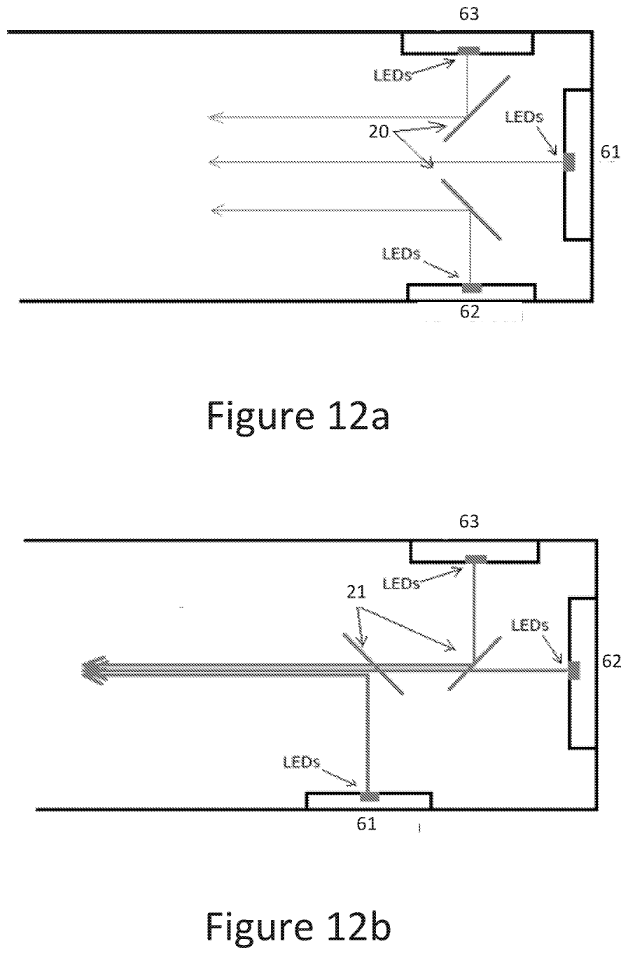

Alternative systems for combining light emitted by different constituent light emitting elements are shown in FIGS. 12a and 12b. These examples consider the combination of light of different colours, it will be appreciated that the constituent light emitting elements may differ by other characteristics.

Referring to FIG. 12a, there is shown an embodiment of a light combining structure in which a plurality of constituent light emitting elements 61, 62, 63 are arranged adjacent mirrors 20, wherein the mirrors are arranged to redirect and combine the light from each of the constituent light emitting elements. Such a light combining structure may be present in a light emitting element; equally such a light combining structure may be used to combine light from a plurality of light emitting elements.

Referring to FIG. 12b, the light combining structure may comprise one or more partially reflective mirrors 21, where these partially reflective mirrors are arranged to enable the passage in at least one direction of (at least a portion of) the light from the light emitting elements 61, 62, 63.

As shown in FIGS. 12a and 12b, the constituent light emitting elements may be located on a plurality of sides of the light combining structure, where this enables the provision of a compact light emitting element in which each of the constituent light emitting elements are separate and have different control circuits.

### Control Electronics and Graphics Generation

The generation of the input graphical image is only briefly considered here, as it will be appreciated that a wide variety of images can be displayed using the display described herein. The input image may, for example, be created by anything from a simple embedded system (for low information applications, e.g. text) through to high-end graphics processing units (GPUs) for immersive VR.

In some embodiments, the control electronics of the display is designed to have a conventional digital display input (HDMI, DVI etc); the input image is read into an internal buffer from which it is scanned out in the format required by the particular display implementation. For example, the input image may arrive in row-by-row format and then be provided to the control electronics of the light emitting elements in column-by-column format.

To simplify the control electronics and to improve cost/performance the image generator may be arranged to output an image which is rotated by 90 degrees; the effect is then that the image is delivered to the display already structured in column format and thus less complex buffering is needed (especially if the image generation rate and display fresh rate are the same).

The control electronics comprises a receiving system to receive the input image and to perform buffering (if necessary) to match the input image and output display characteristics, a read-out system to output the image with the correct timing to the light emitting elements, and any requisite drivers. The total volume required for such electronics and drivers is typically less than 500 cc, which may be packaged as, e.g., a 10×16×2 cm box. These control electronics are typically small and lightweight and so could be worn on the body of a user, e.g. on a belt with a short fibre-optic cable bundle (and/or bundle of light guiding elements) that connects the control electronics to a headset with a display. Equally, the control electronics may be attached to a PC or workstation with a longer fibre-optic cable (comprising the light guiding elements) connecting the control electronics to a headset. Equally, the control electronics may be located in a headset (e.g. so that light guiding elements are not needed).

A suitable cable diameter (e.g. for the light guiding part 30) can be estimated from the size and total number of individual light guiding elements. Using 0.125 mm PMMA fibre and 1,440 light emitting elements (so as to match current high-end headsets) the total cable area can be computed as follows: Cross-sectional area of a single strand: (0.125/2)\hat{ }2*PI=0.01227 sq. mm; total cross-sectional area of 1,440 strands: 0.01277*1440=17.67 sq. mm.

The area of the cable is dependent on the packing density of the light guiding elements. In embodiments that use light guiding elements with a circular cross section, an effective area using hexagonal packing is approximately: 17.67/0.9069=19.48 sq. mm (or about 20 sq mm). This leads to a cable diameter (using the equation A=Pi*R\hat{ }2) of 2*sqrt(20/Pi)=5.05 mm.

In practice, a cable of greater diameter is typically used for increased flexibility and/or to enable the inclusion of reinforcement (e.g. the cable may comprise rigid reinforcing elements). The cable diameter (which cable comprises the light guiding elements) may be at least 5 mm, at least 8 mm, at least 10 mm, and/or at least 15 mm.

In some embodiments, smaller diameter light guiding elements are used so as to reduce the cable size. This may involve using more expensive light guiding elements so as to provide a small diameter cable. For example, the light guiding elements may have diameters of no greater than 0.2 mm, no greater than 0.1 mm, and/or no greater than 0.05 mm. The cable diameter may be no greater than 10 mm, no greater than 5 mm, no greater than 2 mm, and/or no greater than 1 mm.

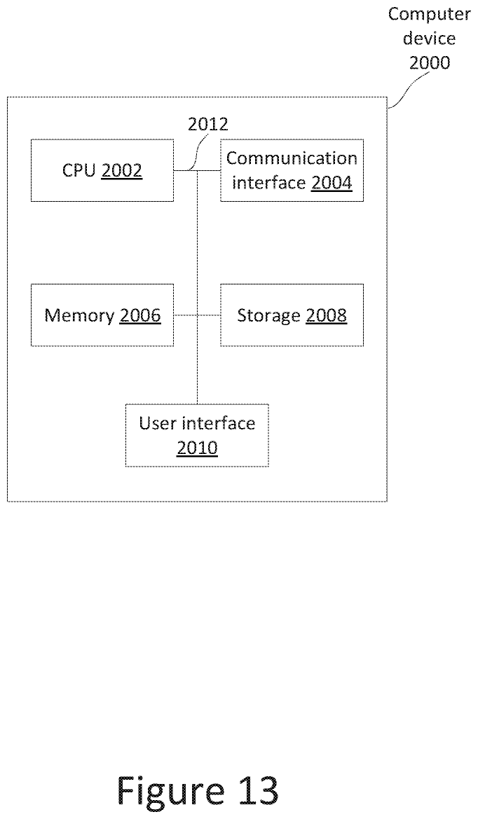

The display comprises a computer device that typically comprises at least the light emitting elements and the control electronics. Referring to FIG. 13, there is shown componentry of an exemplary computer device 2000 on which the display may be implemented. The computer device 2000 comprises a processor in the form of a CPU 2002, a communication interface 2004, a memory 2006, storage 2008, and a user interface 2010 coupled to one another by a bus 2012.

The CPU 2002 executes instructions, including instructions stored in the memory 2006 and/or the storage 2008.

The communication interface 2004 facilitates communication between the headset and one or more further computer devices. The communication interface may, for example, comprise an ethernet interface, a universal serial bus (USB) cable interface, and/or a high definition multimedia interface (HDMI). The communication interface may be a wired interface and/or a wireless interface.

The memory 2006 stores instructions and other information for use by the CPU 2002. The memory is the main memory of the computer device 2000. It usually comprises both Random Access Memory (RAM) and Read Only Memory (ROM).

The storage 2008 provides mass storage for the computer device 2000. In different implementations, the storage is an integral storage device in the form of a hard disk device, a flash memory or some other similar solid state memory device, or an array of such devices. The storage may also, or alternatively, comprise a removeable storage, such as a USB drive and/or a Secure Digital (SD) card.

The user interface 2010 comprises a display and an input/output device. The user interface of the display comprises the one or more light emitting elements and/or comprises the lighting array.

A computer program product is provided that includes instructions for carrying out aspects of the method(s) described below. The computer program product is stored, at different stages, in any one of the memory 2006, the storage and/or a removable storage. The storage of the computer program product is non-transitory, except when instructions included in the computer program product are being executed by the CPU 2002, in which case the instructions are sometimes stored temporarily in the CPU or memory. The removable storage is removable from the computer device 2000, such that the computer program product may be held separately from the computer device from time to time.

Typically, the computer device (and/or the display) comprises, and/or is a part of, a headset, such as a virtual reality (VR) headset, an augmented reality (AR) headset, and/or a mixed reality (XR) headset. The headset may be designed for a desired purpose; for example, where the headset is a VR headset, it may be enclosed so that a wearer is unable to see external light, and conversely where the headset is an AR headset or an XR headset it may be arranged to enable external light through to the eyes of a user so that the user is able to see their surroundings.

Where the display comprises a virtual reality display, the display typically comprises an enclosed box, where the oscillating mirror is located in front of the eyes of the user so that the user is able to see the oscillating mirror.

Where the display comprises an augmented reality display, the oscillating mirror may be arranged so that the image is projected onto an eyeglass of the display (e.g. onto a lens of a pair of glasses, so that the user is able to view the projected image overlaid onto the external environment). Equally, for example, the display may comprise a translucent mirror, e.g. the display may comprise a lens for each of the eyes of the user where the lenses comprise a translucent and/or semi-transparent mirror so that the user is able to see an image that is projected on the mirror while also being able to see through the mirror to the external environment.

In some embodiments, the display comprises (and/or is a part of) a pair of glasses. The display may also be retrofitted to an existing pair of glasses and/or the display may be provided as a kit of parts that comprises a pair of glasses and the componentry disclosed herein.

Typically, the display comprises a pair of oscillating mirrors so that there is an oscillating mirror (and an array of light guiding elements) associated with each eye of the user. Equally, the display may comprise a single oscillating mirror that may be sized so as to display an image to only one eye of the user or that may be sized so as to show an image to both eyes of the user.

Each oscillating mirror is associated with a vibrating element that causes the mirror to oscillate. The vibrating element is typically controlled by a processor so that the frequency of the oscillation can be closely monitored and controlled.

### Mirror

Typically, the mirror 20 comprises a flat square and/or rectangle that oscillates about a central axis. However, other shapes of mirror are envisaged; for example, mirrors may be provided with aspect ratios of 4:3, 16:10, or 1:1.414.

The mirror 20 may be arranged to oscillate about an axis that is offset from a central axis (the central axis being perpendicular to the centre of a side of the mirror). Such an arrangement may be of particular use where a limited amount of space is available and/or where it is desired to produce certain types of (e.g. non-uniform) display.

Suitable dimensions of the mirror 20, and the angle through which the mirror must oscillate, depend on the width of the display, and the distance of the mirror from the eye of a user. Typically, to provide a large display, a large mirror is provided; however, this can lead to a bulky and/or heavy display. Therefore, in some embodiments, the mirror is arranged to move translationally (relative to the light emitting elements). This enables the use of a smaller and lighter-weight mirror. At any instant in time, only a small portion of the mirror is reflecting light from the light emitting elements to the eye of a user, so that a smaller mirror that moves translationally may be used instead of a large mirror.

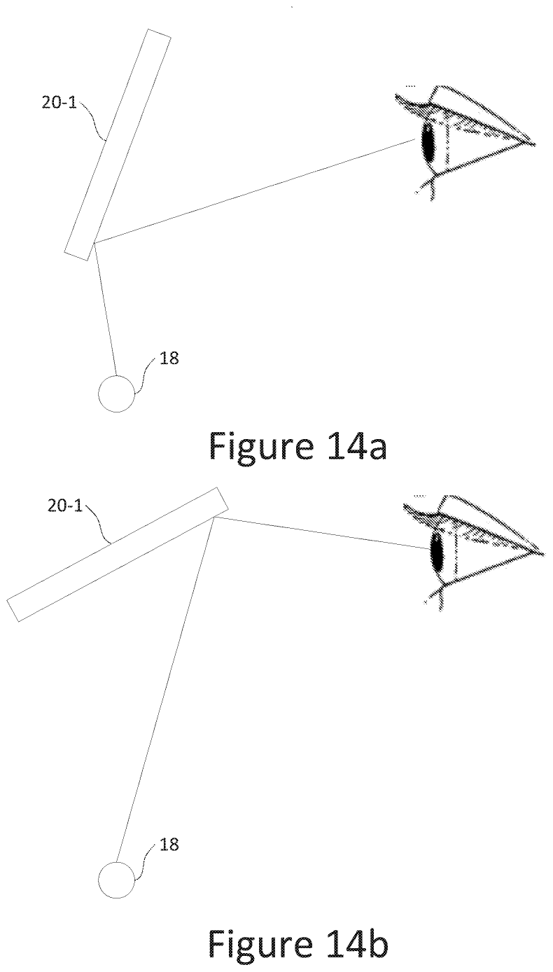

Referring to FIGS. 14a and 14b, there is shown a display with a large mirror 20-1 that oscillates between two extremes (shown in these figures). As shown by these figures, at each extreme, only a small portion of the large mirror is reflecting light from the array 18 of light emitting elements towards the eye of a user.

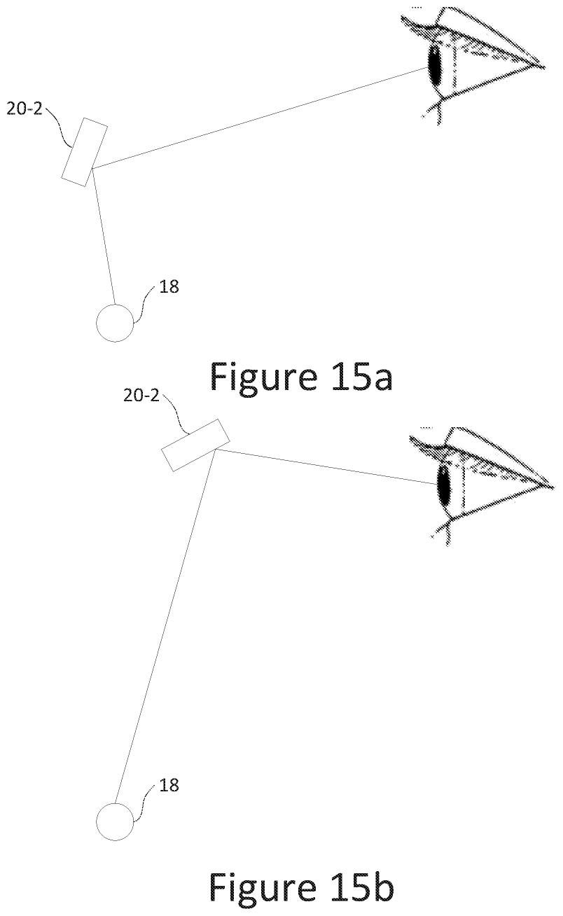

Referring to FIGS. 15a and 15b, there is shown a display that comprises a small mirror 20-2 that is able to both oscillate about an axis of the mirror and to move translationally relative to the light emitting elements and/or the eye of the user (e.g. to move such that the axis of oscillation moves relative to the light emitting elements and/or the eye of the user). The speed of the movement of the mirror depends on the frequency of oscillation (and the desired refresh rate).

The light emitting elements and the viewing location are typically fixed while the mirror moves, so that the distances between the mirror and the light emitting elements and between the mirror and a user's eye can typically be determined in a straightforward manner at each point on the path of the mirror and thus the required angle of the mirror at each point on the path can typically be determined in a relatively straightforward manner. It will be appreciated that more complex arrangements are also possible where one or more of the light emitting elements and the user's eye moves as the mirror moves.

Typically, the display comprises a housing that contains the components of the display, where the mirror 20 is able to move (translationally) within this housing. To enable the movement, the mirror is typically attached to a movement mechanism, such as a mechanical and/or electromagnetic movement mechanism. The mirror may, for example, be held on the end of an arm that is moved between a first end and a second end of a movement path using a motor.

The display may comprise a track along which the mirror 20 is able to move (e.g. translate), where the mirror is able to oscillate about an axis of the mirror as it moves along the track. For example, a vibrating element that causes the oscillation of the mirror may be arranged to move along the track in conjunction with the mirror.

The path along which the mirror 20 moves may be a straight path between a first end and a second end of the path. In some embodiments, the mirror is arranged to move along a curved and/or parabolic path between the first end and the second end. Typically, the mirror is arranged to rotate about an axis of the mirror as it moves along this path. This rotation of the mirror between a first position at a first end of the path and a second position at the second end of the path is separate from the oscillation of the mirror (where the mirror simultaneously moves/translates along the path, rotates so that an angle of the mirror changes with respect to a viewing position, and oscillates to provide the display to the viewer at the viewing position).

Such a moving mirror enables a relatively lightweight and compact display to be used to provide a large image with a wide field of view.

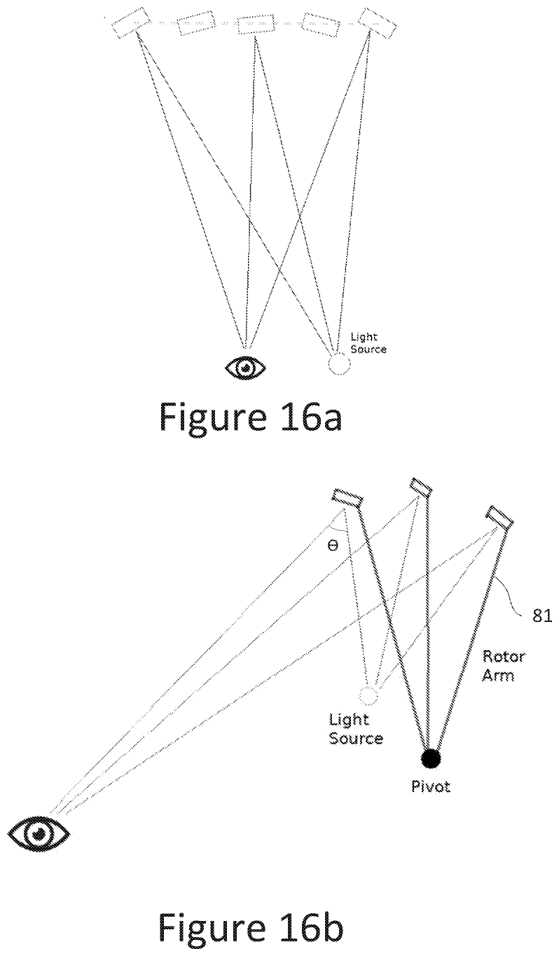

Examples of displays that use a moving mirror are shown in FIGS. 16a and 16b.

Referring to FIG. 16a, there is shown an embodiment in which the mirror 20 is arranged to move along a straight path. As the mirror moves along this path, it is arranged to oscillate so as to provide a visual display (as described above).

As the mirror moves from the first end of the path to the second end of the path, the mirror rotates so that the direction that the mirror is facing changes as the mirror moves along the path. This ensures that the mirror continues to face a user of the display as the mirror moves along the path. The first position and the second position are selected so that, at each position along the path, the mirror directs light to the eye of a user of the display as the mirror oscillates.

Referring to FIG. 16b, there is shown an embodiment in which the mirror 20 is arranged to move along a curved path. As with the straight path, as the mirror moves along this curved path, it is arranged to rotate so as to move between a first position at a first end of the path and a second position at the second end of the path so that, at each position along the path, the mirror directs light to the eye of a user of the display.

As shown in FIG. 16b, the display may comprise a rotor arm 81 that is arranged to rotate about a pivot point so as to move the mirror along the path and so as to rotate the mirror relative to the eye of a user. In this regard, as well as translating the mirror, the rotor arm may rotate the mirror so that the mirror faces the user along the entirety of the path. Typically, the pivot point is located on a side of the display (e.g. on a side portion of a headset) so that each of the eyes of a user is in the same direction from the pivot point.

Where the rotor arm 81 is used, the mirror 20 may be fixed to the rotor arm (e.g. at a fixed angle), where the rotation of the rotor arm still causes a change in the angle between the mirror and the eyes of a user as the rotor arm rotates. Equally, the mirror may be rotatable about the rotor arm so that the mirror rotates due to both the rotation of the rotor arm and a rotation relative to the rotor arm.

More generally, it will be appreciated that numerous mechanisms may be used to implement the movement (translation and/or rotation) of the mirror 20 along a desired path. In generally, the display may comprise a means (such as a rotation mechanism, a cam, a galvanometer, and/or a piezoelectric actuator) for rotating the mirror 20 as the mirror moves along the path. This means is typically arranged to rotate the mirror so that the mirror directs light towards the eye of a user of the display as the mirror moves along the path.

The use of a moving/translating mirror enables the use of a smaller, lighter, mirror than an implementation with a fixed mirror. This typically enables the mirror to be rotated at a higher frequency than in the fixed implementation (so as to provide a high resolution display).

A further benefit of using a moving mirror is that it this can be used to provide an inherently transparent display. In this regard, the (smaller) moving mirror only covers a small portion of the total display area at any one time so that a user may perceive this display as being transparent. Essentially, with the moving mirror, the user perceives a virtual display overlaid on their normal vision, even while the display contents are not generally visible to others (though, in some embodiments, the mirror may be designed to be at least partially transparent so that other users are able to view the display contents). Furthermore, the movement of the mirror will result in the user's eyes not being obscured by the mirror (e.g. so that other people can see the user's eyes during use of the display).

As shown in FIGS. 16a and 16b, the mirror 20 may arranged relative to a light source (e.g. the light emitting elements 18) and the (expected position of an) eye of a user in such a way that various geometric effects act to reduce the amount of rotation required for the mirror to face the user as the mirror moves along the path.

As can be seen in FIGS. 16a and 16b, by locating the light source so that the light source is substantially closer to the mirror 20 than the eye of the user, and by positioning the mirror at an angle to the eye of the user, it is possible to reduce the amount of rotation required for the mirror as the mirror moves along the path.

In some embodiments, the light emitting elements 18 may be located so that the light emitting elements are closer to the mirror 20 than the mirror is to a user. In some embodiments, the mirror may be arranged to rotate about a pivot point, where the mirror may be angled with respect to this pivot point in order to direct light from the light emitting elements to the eye of a user.

In some embodiments, the (expected position of the eye of the) user, the mirror 20, and the light emitting elements 18 are arranged to form an angle (0) that is at least 15°, at least 30°, and/or at least 60° when the mirror is in the first position and/or when the mirror is in the second position.

In some embodiments, the mirror 20 is arranged to rotate by at least 15°, at least 30°, and/or at least 60° as it moves between the first position and the second position. In some embodiments, the mirror is arranged to rotate by no more than 45°, no more than 30°, and/or no more than 15° as it moves between the first position and the second position. Embodiments in which the user, the mirror, and the light emitting elements 18 form a large angle typically enable a smaller rotation of the mirror as the mirror moves between the first position and the second position.

In a specific example, there is considered an arrangement for providing a display with a 30 degree field of view while using a mirror with a width of 1 mm. The mirror is fixed at an angle of 24 degrees to the end of an oscillating arm of length 51 mm with positions (e.g. following the arrangement shown in FIG. 16b). With such an arrangement, the pivot of the rotor arm may be located approximately 90 mm millimetres from the midpoint of a user's eyes along a plane covering the user's eyes. The pivot may be located perpendicular to this plane (as shown in FIG. 16b). With a mirror width of 1 mm, the light source may be reflected to each eye of the user across a range exceeding 30 degrees—providing a display that is similar to that of a 60″ TV seen at a distance of 2.5 metres away.

Considering the moving mirror aspect more generally, there is considered a display that uses a moving mirror in which the required mirror width is a function of the geometry of the components of the display.

Considering first the simple case of a mirror that is mounted on the end of the rotor arm 81 with the viewing position and the rotor arm axis (and, e.g. the light emitting elements 18) being coincident, the mirror may be fixed (in angle) relative to the rotor arm. Then, as the arm rotates, the light emitted by the light emitting elements is reflected back to its origin, which is also the viewing position.

In some embodiments, the pivot of the rotor arm 81 may be located above (or below) a viewing position of a user, where the mirror 20 is arranged to extend from the rotor arm in order to reflect light back towards the eyes of a user as the rotor arm rotates. Such an implementation may be used where the display is part of a headset, where the rotor arm may be located above a viewing portion of the headset. In particular, considering a plane that is coincident with each eye of a user, the rotor arm may be arranged to extend substantially perpendicularly from this plane when the mirror is in a central position. The rotor arm may extend through this plane in a location that is between the eyes of the user.

In many situations, such a design may be impractical because it is typically impractical to have a coincident viewing position and rotor arm. Therefore, as shown in the embodiment of FIG. 16b, the rotor arm 81 and the light emitting elements 18 may be moved away from the eye of a viewer of the display (e.g. the rotor arm may be spaced from the eye of the viewer so that it is not located between the eyes of the viewer when it passes through the aforementioned plane. Moving the rotor arm and the light emitting elements in this way increases the width of the mirror required to provide the display (since the reflection point on the mirror moves from side to side as the arm rotates back and forth).

With such a setup, in which the rotor arm 81 and the light emitting elements 18 are spaced from the eye of a viewer of the display, the minimum mirror width W can be calculated for a given angular scan range S where R is the rotor arm length and φ is the angle made between the mirror centre and the line from the eye to the rotor axis (the axis/pivot about which the rotor arm rotates):

$$W \geq R * tan ( S - φ )$$

The angle φ for a given distance D between the eye and the rotor arm 81/the light emitting elements 18 can be calculated for the maximum scan angle S using the equation:

$$φ = {tan}^{- 1} ( \frac{2 R sin ( S )}{D + 2 R cos ( S )} )$$

In some embodiments, in order to maximise the scan range for a given mirror width, the light emitting elements 18 may be moved relative to the rotor centre and the eye. In this regard, when the light emitting elements 18 and the rotor axis are coincident, only half the scan range can be used because once the mirror moves past the light source (as seen from the eye), the light source is in the way of the field of view of a viewer. This can be addressed by moving the light source off to one side of the line from the eye to the mirror and increasing the mirror width to compensate for this movement. The required mirror width is then a complex function of the geometry and scan range of a particular implementation.

Of importance, changing the angle at which the mirror is fixed to the end of the rotor arm 81 can be used to compensate for moving the light source to the side of the mirror/eye line and so reduce the width of the mirror needed. Therefore, the display may comprise a mirror that is fixed to a rotor arm using a rotatable connection (e.g. a pivot), where the mirror is arranged to rotate about the connection point so as to change an angle of the mirror as the rotor arm rotates around the pivot point. In some embodiments, either the mirror angle and/or the position of the light emitting elements 18 is arranged to vary as a function of the scan angle (e.g. to vary as the rotor arm rotates), where this allows a further reduction of the required mirror width.

In some embodiments, particularly with a moving mirror, the light emitting elements 18 may be visible to external observers in the vicinity of a user of the display (e.g. observers that are looking towards the user from the back of the display). To prevent these observers from being able to view the contents of the display, the display may comprise a first polarising filter that is associated with (e.g. placed over) the light emitting elements and a second polarising filter that is located behind the mirror (e.g. so that the mirror is between a viewer/user of the display and the second polarising filter). The first polarising filter and the second polarising filter may be arranged to reduce, or block, the passage of light from the light emitting elements beyond the mirror; for example, the first polarising filter may be rotated 90 degrees to the second polarising filter so that together these ‘crossed’ polarising filters block the passage of light. Since the light passing to the user arrives via the mirror, this light will not pass through the second polarising filter so that this light is not blocked. In some embodiments, the display comprises an opaque backing that is located behind the mirror (e.g. so that the mirror is between the light emitting elements and the backing) to prevent the leakage of light from the display. Equally, the display may comprise a backing that is semi-transparent and/or a backing that is (or appears) opaque in one direction only; for example, the display/the backing may comprise a one-way mirror.

With a moving mirror implementation, the mirror may be considered to translate (so that, e.g. a centrepoint of the mirror moves with respect to a viewer of the display), to rotate (e.g. so that the angle of the mirror changes with respect to a viewer and/or so that the angle of the mirror about the centrepoint changes), and to oscillate (e.g. to oscillate about the centrepoint). The rotation typically occurs so that the mirror moves between a first rotation position at a first end of a path and a second rotation position at a second end of the path whereas the oscillation typically occurs so that the mirror moves between a first oscillation position and a second oscillation position a plurality of times as the mirror moves between the first position and the second position (e.g. the oscillation frequency is much higher than the rotation frequency).

With regard to the moving mirror implementation, it will be appreciated that similar functionality can be provided using a stationary mirror and moving light emitting elements (or using both a moving mirror and moving light emitting elements). The present disclosure extends to embodiments that use moving, e.g. translating, light emitting elements along with either a stationary or a moving mirror.

In some embodiments, the display comprises a structure for directing light from the light emitting elements 18 to a certain part of the mirror 20. For example, the display may comprise a microelectromechanical (MEMS) system and/or a digital light processing (DLP) device for directing light to a desired part of the mirror.

In some embodiments, the mirror 20 is flexible and/or deformable, where the flexing of the mirror is useable to direct light to a desired part of the mirror.

In some embodiments, the mirror 20 is curved, where this enables an increase of the field of view for a given size of mirror.

In some embodiments, the display comprises a plurality of component mirrors and/or the mirror 20 comprises a plurality of component mirrors. Such an approach provides a wider field of view, but requires precise location of the component mirrors to avoid the gaps between component mirrors being visible to a user.

Where the display comprises a plurality of mirrors, the mirrors may each be associated with the same lighting array. Equally, each mirror may be associated with a corresponding lighting array. Such an arrangement with multiple lighting arrays and mirrors can be used to provide full colour images and/or to provide particularly bright images by directing light from multiple arrays to the eye of a user simultaneously so as to combine the light emitted by these arrays.

It will be appreciated that numerous types of reflective materials could be used to form the mirror 20 and that various shapes and types of mirror are useable (e.g. instead of a flat oscillating mirror, a prismatic rotating mirror could be used).

### Static Usage

Typically, the display is arranged to be portable; for example, the display may be a part of a headset that is worn by a user as they move around an environment. Equally, the display may comprise a fixed display. With a fixed display, heavy and large mirrors are useable (so as to provide a large display and/or an increased resolution). Large displays also enable the lighting array(s) to be located further from the mirror(s) so that typically lenses are not required for large displays. This reduces the number of components of the display (e.g. to simplify maintenance).

The present disclosure envisages displays with a length of at least 0.5 metres, at least 1 metre, and/or at least two metres. The present disclosure envisages displays with at least 1000 light emitting elements, at least 2000 light emitting elements, at least 4000 light emitting elements, and/or at least 10000 light emitting elements.

In a practical example, a display may be provided with a 1 metre tall column of LEDs comprising, say, 4000 RGB LEDs each of effective size 0.25 mm. This provides a display with vertical resolution of 4000 pixels with the horizontal resolution set by the frequency of operation of the LEDs (e.g. a value of 10,000 pixels may be used).

With large displays a viewing structure is typically provided, such as an external lens and/or a pair of external lenses (as found e.g. on binoculars) so that a user is easily able to locate themselves at the correct location to view the display.

Exemplary uses for large displays include high resolution medical imaging and/or the viewing of architectural or engineering plans.

A large display (or indeed a small or portable display or any other type of display disclosed herein) may be combined with a portable headset wherein the headset is connected to the display via a viewing cable. The viewing cable is arranged to transfer the light reflected by the mirror (e.g. the image) to the portable headset (similarly to the way in which the light guiding elements transfer light from the light emitting elements to the mirror). Such a viewing cable may comprise, for example, a fibre optic cable. This arrangement enables a user to put on a portable headset so that they are able to move around an environment while viewing a static display. Such a portable headset can be extremely lightweight and compact since it only needs to provide the light emitted by the fibre optic cable to the eyes of the user (e.g. the headset does not require any electronics or power).

### Oscillating Lighting Array

Typically, the mirror 20 is arranged to oscillate while the light emitting elements 18 remain in a static location (relative to the housing of the display). In some embodiments, the light emitting elements 18 and/or the light guiding elements 30 are arranged to oscillate. For example, a fibre optic light guiding element may be mounted onto the end of a vibrating support where the light guiding element is then able to oscillate. Typically, the light emitting elements and/or the light guiding elements are arranged to oscillate along a single axis (e.g. so that the ends of the light guiding elements move back and forth along this axis) so that the light emitted is projected along a line on the mirror. Effectively, oscillating the light emitting elements and/or the light guiding elements achieves a similar effect as oscillating the mirror.

The oscillation may, for example, be achieved using a vibrating element and/or using a solenoid in concert with a magnet that is attached to the light emitting elements 18 and/or the light guiding elements 30 and/or a mechanical support on which these components are mounted.

Such an embodiment is of particular applicability where flexible light guiding elements are used with the display (e.g. fibre optic cables).

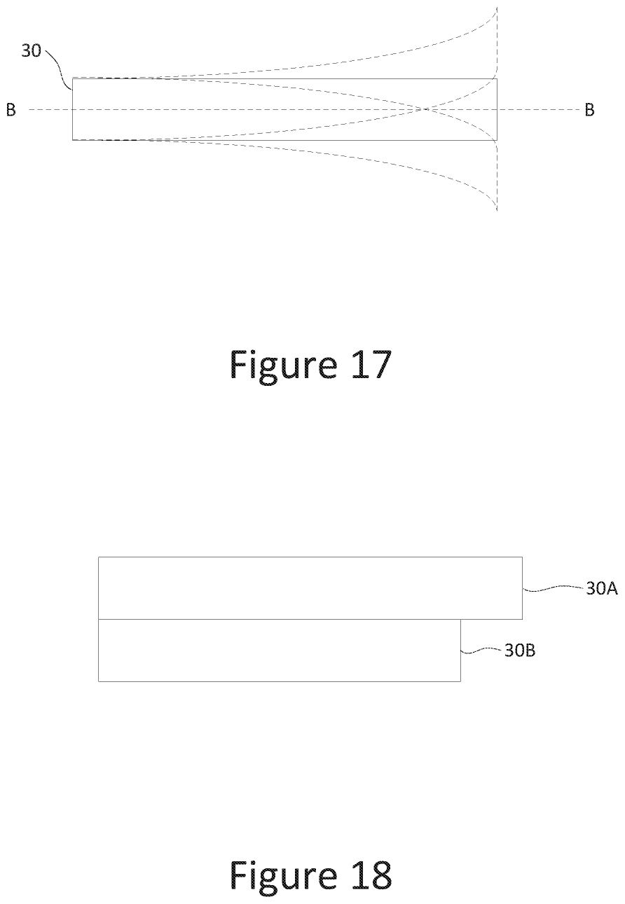

Referring to FIG. 17, there is shown a light guiding element 30 that is arranged to oscillate about an axis BB. The light guiding element is restrained in place at a first end so that the second end moves along a line. Typically, the light guiding element is restrained so that the second end moves along a line as opposed to about a plane. Such a light guiding element may be used with a fixed mirror to provide the display (equally, both of the mirror and the light guiding element may be capable of oscillating).

Referring to FIG. 18, there is shown a display that comprises a plurality of light guiding elements 30A, 30B (and/or light emitting elements) that are arranged to oscillate, where the output ends of the light guiding elements are axially offset (e.g. offset in the direction of the emission of light from the light guiding elements). Such an arrangement can be used to provide a volumetric (3-dimensional) display as the offset of the light guiding elements provides depth to an image. The display may comprise a plurality of light guiding elements with different axial offsets (e.g. a first and second light guiding element may be offset by a first distance with a first and third light guiding element being offset by a different second distance).

In some embodiments, the display comprises a plurality of axially offset light emitting elements so as to produce a volumetric display.

Typically, with such a display, each of the light guiding elements is attached to a shared vibrating support, such that the amount of oscillation of the output ends of the light guiding elements is dependent on the distance of that output end from the vibrating support. By using supports (and light guiding elements) that do not emit light themselves, these components are effectively concealed by light emitted from the output ends of the light guiding elements.

### Projection

Typically, a user of the display views an image by looking directly at the mirror 20. The present disclosure extends to a projector, e.g. a display that is arranged to project the image onto another surface that can then be viewed by a user.

In particular, the display may comprise a projecting lens that is arranged to receive light reflected onto the mirror. Typically, the projecting lens is arranged to enlarge the image so as to form a large projected image.

Where a projector is provided, it is typically desirable to use particularly bright light emitting elements and/or to provide a plurality of lines of light emitting elements to ensure that the display is visible.

The present disclosure considers a portable projector based on the disclosures herein; for example, a projector may be provided as a head-mounted projector that enables a user to project an image in front of them.

Where the display comprises sensors, such as head tracking sensors, the projector may be arranged to project a virtual object onto a fixed point in space. As the user moves, the projector may be arranged to show a different perspective and/or part of the object so as to provide a virtual/augmented reality object to a user, which object does not require the user to wear eyeglasses. Such a projected augmented reality object may also be visible to other people in the vicinity of the user so that the projector can be used to provide a shared augmented reality experience.

To ensure that a virtual object is aligned with a user's gaze, the display (e.g. the mirror 20) may comprise a partially reflective mirror, with the image being projected by reflection from the mirror as well as being viewed through the mirror. Such a partially reflective mirror can be used so that physical objects placed in front of the screen cover their own shadow as is described in Davidhazy, A. “Front Projection a useful compositing special effects technique”; Rochester RIT Institute of Technology, Scholar Works, 2008: https://scholarworks.rit.edu/cgi/viewcontent.cgi?referer=&httpsredir=1&article=1439&context=article.

In order to increase the brightness of the projection, the projector may be used as part of a system that further comprises a retroreflective (e.g. ‘Scotchlite’) material that may, for example, be placed on a wall in front of the projector. Such a retroflected display increases the brightness of the image that is returned to the wearer's eye. As a result, the brightness of the light emitting elements can be considerably reduced to such an extent that the projected image is visible only on the screen and is not visible (or is only faintly visible) on any other surfaces.

The use of a retroreflective material enables the use of relatively dim light emitting elements and ensures that objects surrounding the retroreflective material are not illuminated. This may be used, for example, to project a film onto a screen. Where the projector is a head mounted display, the selective use of retroreflective material may, for example, be used to draw a user's attention to a particular area of an environment or may be used in situations where a user is searching for the retroreflective material (e.g. as part of an easter egg hunt).

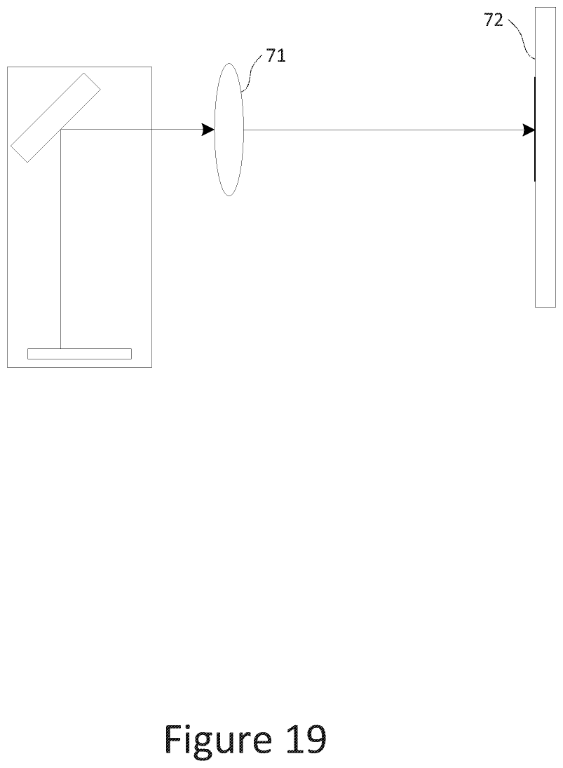

Such a system is shown in FIG. 19, which shows a display comprising a projecting lens 71 that projects an image onto a screen 72. The screen may comprise a retroreflective material to increase the brightness of the image.

With the projector as disclosed, if a physical object is placed in front of the screen 72, then this physical object will block the light emitted from the projector. By using retroreflective materials on the screen, a dim light can be provided so that the light is not visible (or is scarcely visible) on the physical object. Therefore, the projector enables an augmented reality display to be provided in which a virtual object (projected onto the screen) is occluded when an object passes in front of a screen-such occlusion can be difficult to implement with conventional augmented reality systems (particularly when a virtual object is only partially occluded by a physical object).

In some embodiments, the projector is used to project an image onto the rear of a screen (so that the image is visible to people viewing the front of the screen). Such a method of projection is of particular use where the display comprises a screen, so that the user is able to project an image onto this screen of the display.

### ALTERNATIVES AND MODIFICATIONS

Various other modifications will be apparent to those skilled in the art. For example, various arrangements may be used to combine light and/or to collimate light. Similarly, various shapes and sizes of light emitting elements may be used and various types of light guiding elements may be used.

It will be understood that the present invention has been described above purely by way of example, and modifications of detail can be made within the scope of the invention.

Reference numerals appearing in the claims are by way of illustration only and shall have no limiting effect on the scope of the claims.

1. A display comprising:
a mirror arranged to rotate about an axis of rotation; and
a plurality of light emitting elements arranged to project light onto the mirror;
wherein one or more of the light emitting elements comprises:
a light emitting component; and
a light guiding component,
wherein the light guiding component is arranged:
to receive light from the light emitting component at a first end; and
to emit the light onto the mirror at a second end; and
wherein:
the light guiding components are arranged to transfer light between the first end and the second end via total internal reflection (TIR); and/or
the light guiding components comprise fibre optic elements.

2-3. (canceled)

4. The display of claim 1, wherein each of the light emitting elements comprises a light emitting component and a light guiding component.

5. (canceled)

6. The display of claim 1, wherein the light guiding components are flexible.

7. The display of claim 1, wherein the light guiding components at least 50 mm long, at least 100 mm long, and/or at least 1 m long.

8. The display of claim 1, comprising a first part and a second part, wherein:
the first part comprises one or more light emitting components;
the second part comprises the mirror; and
the first part and the second part are connected by the one or more light guiding components.

9. The display of claim 1, wherein:
the second end of a light guiding component of the first light emitting element is offset from the second end of a light guiding component of the second light emitting element in a direction aligned with the axis of rotation; and
the second end of the light guiding component of the first light emitting element is offset from the second end of the light guiding component of the second light emitting element in a direction perpendicular to the axis of rotation.

10. The display of claim 1, wherein the light emitting elements are rectangular light emitting elements and/or wherein the light emitting elements are arranged to output a rectangular pattern of light.

11. The display of claim 1, wherein one or more, or each, of the light emitting elements is associated with a mask that is arranged to block and/or filter a portion of the light emitted by said light emitting elements, preferably a photolithographic mask.

12. The display of claim 11, wherein each mask is arranged:
to allow the passage of light through an aperture of the mask, preferably wherein the aperture is rectangular; and/or
to block the passage of light away from, and/or other than from, the aperture.

13. The display of claim 1, wherein each of the light emitting elements comprises a plurality of constituent light emitting elements (and/or light emitting components), wherein each light emitting element further comprises a combining structure for combining the light emitted by the constituent light emitting elements.

14-18. (canceled)

19. The display of claim 1, wherein the light emitting elements comprise light guiding components, which light guiding components are arranged to vibrate and/or oscillate so as to project a line of light onto the mirror.

20. (canceled)

21. The display of claim 1, wherein a first light guiding element and a second light guiding element of the plurality of light guiding elements are offset in a direction of emission of light from the light emitting elements, thereby providing a volumetric display.

22. The display of claim 1, wherein the mirror is arranged to move translationally relative to the light emitting elements and/or relative to a housing of the display, preferably wherein the mirror is arranged to move along a straight path or a curved path.

23-27. (canceled)

28. The display of claim 1, comprising a plurality of lines of light emitting elements, wherein each of the lines of light emitting elements comprises one or more light emitting elements, and wherein:
the light emitting elements of a first line of light emitting elements are offset from the light emitting elements of a second line of light emitting elements in a direction aligned with the axis of rotation of the mirror; and
the light emitting elements of the first line are offset from the light emitting elements of the second line in a direction perpendicular to the axis of rotation.

29. The display of claim 28, wherein each of the lines of light emitting elements is arranged to have:
a fill factor along the axis of rotation that is less than or equal to 66%, less than or equal to 50%, and/or less than or equal to 33%; and/or
a percentage fill factor along the axis of rotation that is approximately equal to 100% divided by the number of lines of light emitting elements, and/or 100% divided by the number of lines of a type of light emitting elements.

30. The display of claim 1, wherein the combination of lines of light emitting elements is arranged to have a fill factor along the axis of rotation that is one or more of: greater than or equal to 90%, greater than or equal to 95%, greater than or equal to 100%, and/or substantially equal to 100%.

31-38. (canceled)

39. A headset comprising the display of claim 1.

40. A projector comprising the display of claim 1.

41-43. (canceled)

44. The display of claim 1, wherein:
a first light emitting element of the plurality of light emitting elements is offset from a second light emitting element of the plurality of light emitting elements in a direction aligned with the axis of rotation; and
the first light emitting element is offset from the second light emitting element of the plurality of light emitting elements in a direction perpendicular to the axis of rotation.

45. The display of claim 44, wherein:
the offset in the direction aligned with the axis of rotation is less than a side length and/or diameter of the light emitting elements; and/or
the offset in the direction perpendicular to the axis of rotation is less than a side length and/or diameter of the light emitting elements.
